(19) United States
(12) Patent Application Publication
(10) Pub. No.: US 2019/0181461 A1
(43) Pub. Date: Jun. 13, 2019

(54) MEMBRANE-ELECTRODE ASSEMBLIES AND ELECTROCHEMICAL CELLS AND LIQUID FLOW BATTERIES THEREFROM

(71) Applicant: 3M INNOVATIVE PROPERTIES COMPANY, St. Paul, MN (US)

(72) Inventors: Brian T. Weber, Maplewood, MN (US); Brandon A. Bartling, Woodbury, MN (US); Onur Sinan Yordem, St. Paul, MN (US); Andrew T. Haug, Woodbury, MN (US); John E. Abulu, Woodbury, MN (US); Gregory M. Haugen, Edina, MN (US); Kazuki Noda, Tokyo (JP); Shunsuke Suzuki, Tokyo (JP); Bharat R. Acharya, Woodbury, MN (US); Daniel M. Pierpont, North St. Paul, MN (US); David J. Miller, Menomonie, WI (US); Eric J. Iverson, Eau Claire, WI (US)

(21) Appl. No.: 16/324,519

(22) PCT Filed: Aug. 9, 2017
(86) PCT No.: PCT/IB2017/054869

§ 371 Date: Feb. 8, 2019

Related U.S. Application Data
(60) Provisional application No. 62/373,638, filed on Aug. 11, 2016.

(51) Int. Cl. H01M 8/0273; H01M 8/0276; H01M 8/0297; H01M 8/18

(52) U.S. Cl. CPC H01M 8/0273; H01M 8/188; H01M 8/0297; H01M 8/0276

(57) ABSTRACT

The present disclosure relates membrane-electrode assemblies and electrochemical cells and liquid flow batteries produced therefrom. The membrane-electrode assemblies include a first porous electrode; an ion permeable membrane, having a first major surface and an opposed second major surface; a first discontinuous transport protection layer disposed between the first porous electrode and the first major surface of the ion permeable membrane; and a first adhesive layer in contact with the first porous electrode and at least one of the first discontinuous transport protection layer and the ion permeable membrane. The first adhesive layer is disposed along the perimeter of the membrane-electrode assembly. The first porous electrode and first discontinuous transport protection layer, without the presence of the first adhesive layer, are not an integral structure and the membrane-electrode assembly is an integral structure

### FIELD

The present invention generally relates to assemblies useful in the fabrication of electrochemical cells and batteries. In particular, the present invention relates to membrane-electrode assemblies and electrochemical cells and liquid flow batteries produced therefrom. The disclosure further provides methods of making the electrode assemblies and membrane-electrode assemblies.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one embodiment, the present disclosure provides a membrane-electrode assembly including: a first porous electrode;

an ion permeable membrane, having a first major surface and an opposed second major surface;

a first discontinuous transport protection layer disposed between the first porous electrode and the first major surface of the ion permeable membrane; and

a first adhesive layer in contact with the first porous electrode and at least one of the first discontinuous transport protection layer and the ion permeable membrane, wherein the first adhesive layer is disposed along the perimeter of the membrane-electrode assembly, wherein the first porous electrode and first discontinuous transport protection layer, without the presence of the first adhesive layer, are not an integral structure and wherein the membrane-electrode assembly is an integral structure.

In another embodiment, the membrane-electrode assembly further includes a second adhesive layer in contact with the first major surface of the ion permeable membrane and the first discontinuous transport protection layer, wherein the second adhesive layer adheres the first discontinuous transport protection layer to the ion permeable membrane and wherein the second adhesive layer is disposed along the perimeter of the membrane-electrode assembly.

In another embodiment, the membrane-electrode assembly further includes a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus and, optionally, includes at least one of a first gasket adhesive layer in contact with the first major surface of the first gasket and the first major surface of the ion permeable membrane; and a second adhesive layer in contact with the second major surface of the first gasket and the first discontinuous transport protection layer.

In yet another embodiment, the membrane-electrode assembly further includes a second porous electrode and a second discontinuous transport protection layer disposed between the second porous electrode and the second major surface of the ion permeable membrane.

In another embodiment, the membrane-electrode assembly which includes a second porous electrode and a second discontinuous transport protection layer further includes a third adhesive layer in contact with the second porous electrode and at least one of the second discontinuous transport protection layer and the ion permeable membrane, wherein the third adhesive layer is disposed along the perimeter of the membrane-electrode assembly, wherein the second porous electrode and second discontinuous transport protection layer, without the presence of the third adhesive layer, are not an integral structure and wherein the membrane-electrode assembly is an integral structure.

In another embodiment, the membrane-electrode assembly which includes a second porous electrode and a second discontinuous transport protection layer further includes a fourth adhesive layer in contact with the second major surface the ion permeable membrane and the second discontinuous transport protection layer, wherein the fourth adhesive layer adheres the second discontinuous transport protection layer to the ion permeable membrane and wherein the fourth adhesive layer is disposed along the perimeter of the membrane-electrode assembly.

In another embodiment, the membrane-electrode assembly which includes a second porous electrode and a second discontinuous transport protection layer further includes a second gasket having a first major surface and a second major surface disposed between the ion permeable membrane and the second discontinuous transport protection layer, wherein the second gasket is disposed along the perimeter of the membrane-electrode assembly and the second gasket is in the shape of an annulus and, optionally, includes at least one of a second gasket adhesive layer in contact with the first major surface of the second gasket and the second major surface of the ion permeable membrane and a fourth adhesive layer in contact with the second major surface of the second gasket and the second discontinuous transport protection layer.

In yet another embodiment, the present disclosure provides a membrane-electrode assembly including:

a first porous electrode; an ion permeable membrane, having a first major surface and an opposed second major surface,

a first discontinuous transport protection disposed between the first porous electrode and the ion permeable membrane; and

a first adhesive layer in contact with the first porous electrode and at least one of the first discontinuous transport protection layer and the ion permeable membrane, wherein the first adhesive layer is a plurality of first adhesive regions disposed at least within the interior of the membrane-electrode assembly and the area of the first plurality of adhesive regions, in the plane of the membrane electrode assembly, is less than at least 50 percent of the projected area of the membrane electrode assembly, wherein the first porous electrode and first discontinuous transport protection layer, without the presence of the first adhesive layer, are not an integral structure and wherein the membrane-electrode assembly is an integral structure.

In another embodiment, the present disclosure provides an electrochemical cell including a membrane-electrode assembly according to any one of the membrane-electrode assemblies of the present disclosure.

In another embodiment, the present disclosure provides a liquid flow battery including at least one membrane-electrode assembly according to any one of the membrane-electrode assemblies of the present disclosure.

### BRIEF DESCRIPTION OF THE DRAWINGS

FIG. 1A is a schematic cross-sectional side view, through line 1A of FIG. 1B, of an exemplary membrane-electrode assembly according to one exemplary embodiment of the present disclosure.

FIG. 1B is a schematic top view in the plane of the adhesive layer, of the exemplary membrane-electrode assembly of FIG. 1A, according to one exemplary embodiment of the present disclosure.

FIG. 1C is a schematic cross-sectional side view of an exemplary membrane-electrode assembly according to one exemplary embodiment of the present disclosure.

FIG. 1D is a schematic cross-sectional side view of an exemplary membrane-electrode assembly according to one exemplary embodiment of the present disclosure.

FIG. 1E is a schematic cross-sectional side view of an exemplary membrane-electrode assembly according to one exemplary embodiment of the present disclosure.

FIG. 1F is a schematic cross-sectional side view of an exemplary membrane-electrode assembly according to one exemplary embodiment of the present disclosure.

FIG. 1G is a schematic cross-sectional side view of an exemplary membrane-electrode assembly according to one exemplary embodiment of the present disclosure.

FIG. 1H is a schematic cross-sectional side view of an exemplary membrane-electrode assembly according to one exemplary embodiment of the present disclosure.

FIG. 1I is a schematic cross-sectional side view of an exemplary membrane-electrode assembly according to one exemplary embodiment of the present disclosure.

FIG. 1J is a schematic cross-sectional side view of an exemplary membrane-electrode assembly according to one exemplary embodiment of the present disclosure.

FIG. 1K is a schematic cross-sectional side view of an exemplary membrane-electrode assembly according to one exemplary embodiment of the present disclosure.

FIG. 1L is a schematic cross-sectional side view of an exemplary membrane-electrode assembly according to one exemplary embodiment of the present disclosure.

FIG. 1M is a schematic cross-sectional side view of an exemplary membrane-electrode assembly according to one exemplary embodiment of the present disclosure.

FIG. 1N is a schematic cross-sectional side view, through line 1N of FIG. 1P, of an exemplary membrane-electrode assembly according to one exemplary embodiment of the present disclosure.

FIG. 1P is a schematic top view in the plane of the adhesive layer, of the exemplary membrane-electrode assembly of FIG. 1N, according to one exemplary embodiment of the present disclosure.

FIG. 2A is a schematic cross-sectional side view, through line 2A of FIG. 2B, of an exemplary membrane-electrode assembly according to one exemplary embodiment of the present disclosure.

FIG. 2B is a schematic top view in the plane of the adhesive layer, of the exemplary membrane-electrode assembly of FIG. 2A, according to one exemplary embodiment of the present disclosure.

FIG. 2C is a schematic cross-sectional side view of an exemplary membrane-electrode assembly according to one exemplary embodiment of the present disclosure.

FIG. 2D is a schematic cross-sectional side view of an exemplary membrane-electrode assembly according to one exemplary embodiment of the present disclosure.

FIG. 2E is a schematic cross-sectional side view of an exemplary membrane-electrode assembly according to one exemplary embodiment of the present disclosure.

FIG. 3A is a schematic top view of an exemplary discontinuous transport protection layer according to one exemplary embodiment of the present disclosure.

FIG. 3B is a schematic cross-sectional side view of the exemplary discontinuous transport protection layer of FIG. 3A, through line 3B of FIG. 3A, according to one exemplary embodiment of the present disclosure.

FIG. 3C is a schematic top view of an exemplary discontinuous transport protection layer according to one exemplary embodiment of the present disclosure.

FIG. 3D is a schematic cross-sectional side view of the exemplary discontinuous transport protection layer of FIG. 3C, through line 3D of FIG. 3C, according to one exemplary embodiment of the present disclosure.

FIG. 3E is a schematic top view of an exemplary discontinuous transport protection layer according to one exemplary embodiment of the present disclosure.

FIG. 3F is a schematic cross-sectional side view of the exemplary discontinuous transport protection layer of FIG. 3E, through line 3F of FIG. 3E, according to one exemplary embodiment of the present disclosure.

FIG. 3G is a schematic top view of an exemplary discontinuous transport protection layer according to one exemplary embodiment of the present disclosure.

FIG. 3H is a schematic cross-sectional side view of the exemplary discontinuous transport protection layer of FIG. 3E according to one exemplary embodiment of the present disclosure.

FIG. 4 is a schematic cross-sectional side view of an exemplary electrochemical cell according to one exemplary embodiment of the present disclosure.

FIG. 5 is a schematic cross-sectional side view of an exemplary electrochemical cell stack according to one exemplary embodiment of the present disclosure.

FIG. 6 is a schematic view of an exemplary single cell, liquid flow battery according to one exemplary embodiment of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure, if a substrate or a surface of a substrate is “adjacent” to a second substrate or a surface of a second substrate, the two nearest surfaces of the two substrates are considered to be facing one another. They may be in contact with one another or they may not be in contact with one another, an intervening third layer(s) or substrate(s) being disposed between them.

Throughout this disclosure the phrase “non-conductive” refers to a material or substrate that is non-electrically conductive, unless otherwise stated. In some embodiments, a material or substrate is non-electrically conductive if it has an electrical resistivity of greater than about 1000 ohm-m

Throughout this disclosure, an aqueous based solution is defined as a solution wherein the solvent includes at least 50% water by weight. A non-aqueous based solution is defined as a solution wherein the solvent contains less than 50% water by weight.

Throughout this disclosure, unless indicated otherwise, the word “fiber” is meant to include both the singular and plural forms.

Throughout this disclosure fluid communication between a first surface and a second surface of a substrate means that a fluid, e.g. gas and/or liquid, is capable of flowing from a first surface of the substrate, through the thickness of a substrate, to a second surface of the substrate. This inherently implies that there is a continuous void region extending from the first surface of the substrate, through the thickness of the substrate, to a second surface of the substrate.

Softening Temperature is the glass transition temperature and/or the melting temperature of a polymer.

Volume Porosity: the volume of the open region of the discontinuous transport protection layer divided by the total volume, i.e. bulk volume, of the discontinuous transport protection layer.

Open Area Porosity: with respect to a major surface of a woven, non-woven or mesh structure, the ratio of the total area of the open regions at the major surface to the total surface area of the major surface, i.e. the projected surface.

In some embodiments, an integral structure includes a structure that can be held in any orientation in space and does not separate into at least two components, due to the force of gravity.

### DETAILED DESCRIPTION

A single electrochemical cell, which may be used in the fabrication of a liquid flow battery (e.g. a redox flow battery), generally, includes two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The ion permeable membrane along with at least one of the anode and cathode will be referred to herein as a membrane-electrode assembly (MEA). In a redox flow battery containing a single electrochemical cell, for example, the cell would also include two current collectors, one adjacent to and in contact with the exterior surface of the anode flow plate and one adjacent to and in contact with the exterior surface of the cathode flow plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolylte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size and number of membrane-electrode assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (e.g. anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the ion permeable membrane. Thus, the material making up the ion permeable membrane may be an expensive specialty polymer. As hundreds of MEAs may be required per cell stack and battery, the ion permeable membrane may be a significant cost factor with respect to the overall cost of the MEA and the overall cost of a cell and battery. As it is desirable to minimize the cost of the MEAs, one approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff materials, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved membrane-electrode assemblies that can prevent this localized shorting while maintaining the required ion transport through the membrane without inhibiting the required oxidation/reduction reaction of the electrochemical cells and batteries fabricated therefrom.

The present disclosure provides membrane-electrode assemblies that include at least one porous electrode, e.g. a first porous electrode, an ion permeable membrane, at least one discontinuous transport protection layer disposed between the first porous electrode and the first major surface of the ion permeable membrane and at least one adhesive layer in contact with the first porous electrode and at least one of the first discontinuous transport protection layer and the ion permeable membrane. The at least one adhesive layer may be disposed along the perimeter of the membrane-electrode assembly. The membrane-electrode assembly may be an integral structure, due to the inclusion of the at least one adhesive layer. The discontinuous transport protection layer and porous electrode, without the presence of the at least one adhesive layer (i.e. without the addition of the one or more adhesive layers), are not an integral structure. The membrane-electrode assemblies of the present disclosure may be used in an electrochemical cell and/or liquid flow battery. The discontinuous transport protection layer protects the ion permeable membrane from puncture by the fibers of the electrode and thus prevents localized shorting that has been found to be an issue in other MEAs, electrochemical cell and liquid flow battery designs. The discontinuous transport protection layers of the present disclosure may also improve fluid flow within a membrane-electrode assembly and subsequently fluid flow within an electrochemical cell and/or battery. The term “transport” within the phrase “transport protection layer” refers to fluid transport within and/or through the protection layer. The term “discontinuous” refers to the porous nature of the transport protection layer, which allows fluid communication through at least its thickness, i.e. between the first major surface and opposed second major surface of the discontinuous transport protection layer. This may lead to improved, i.e. decreased, or at least not significantly altered cell resistance, contrary to what one might expect to occur with the inclusion of an additional layer within the membrane-electrode assembly and subsequently with the inclusion of an additional layer in an electrochemical cell and/or battery. The membrane-electrode assemblies with at least one discontinuous transport protection layer are useful in the fabrication of liquid flow, e.g. redox flow, electrochemical cells and batteries. Liquid flow electrochemical cells and batteries may include cells and batteries having a single half-cell being a liquid flow type or both half-cells being a liquid flow type. The present disclosure also includes liquid flow electrochemical cells and batteries containing membrane-electrode assemblies that include at least one discontinuous transport protection layer.

The present disclosure provides membrane-electrode assemblies comprising: (i) a first porous electrode, (ii) an ion permeable membrane, having a first major surface and an opposed second major surface, (iii) a first discontinuous transport protection layer disposed between the first porous electrode and the first major surface of the ion permeable membrane; and (iv) a first adhesive layer in contact with the first porous electrode and at least one of the first discontinuous transport protection layer and the ion permeable membrane, wherein the first adhesive layer is disposed along the perimeter of the membrane-electrode assembly, wherein the first porous electrode and first discontinuous transport protection layer, without the presence of the first adhesive layer, are not an integral structure and wherein the membrane-electrode assembly is an integral structure. Generally, the porous electrodes and the discontinuous transport protection layers of the present disclosure each have a first major surface and opposed second major surface. In some embodiments, the first adhesive layer may be in contact with at least one of or both the first surface of the ion permeable membrane and the first discontinuous transport protection layer. In some embodiments, the first adhesive layer may be in contact with at least one of or both the first surface of the ion permeable membrane and the porous electrode. The first adhesive layer may be at least partially embedded in at least one of the first discontinuous transport protection layer and the first porous electrode. In some embodiments, the first adhesive layer adheres the first discontinuous transport protection layer to the first porous electrode. In some embodiments, the first adhesive layer adheres at least one of the first discontinuous transport protection layer and the first porous electrode to the ion permeable membrane. The first adhesive layer may be a continuous adhesive layer or a discontinuous adhesive layer. The membrane-electrode assembly may further include a second adhesive layer in contact with the first major surface of the ion permeable membrane and the first discontinuous transport protection layer, wherein the second adhesive layer adheres the first discontinuous transport protection layer to the ion permeable membrane. The second adhesive layer is disposed along the perimeter of the membrane-electrode assembly. The first adhesive layer and/or second adhesive layer may each be one of a continuous adhesive layer or a discontinuous adhesive layer. A continuous adhesive layer has a single, contiguous adhesive region. A discontinuous adhesive layer has at least two isolated adhesive regions.

The membrane-electrode assemblies of the present disclosure may further include as second porous electrode, a second discontinuous transport protection layer disposed between the second porous electrode and the second major surface of the ion permeable membrane and, optionally, a third adhesive layer. The third adhesive layer may be disposed along the perimeter of the membrane-electrode assembly, e.g. at least a portion of the third adhesive layer is disposed along the perimeter of the membrane-electrode assembly. The third adhesive layer may be disposed between the ion permeable membrane and at least one of the second porous electrode and the second discontinuous transport protection layer. In some embodiments, the third adhesive layer may be in contact with at least one of or both the second surface of the ion permeable membrane and the second discontinuous transport protection layer. In some embodiments, the third adhesive layer may be in contact with at least one of or both the second surface of the ion permeable membrane and the second porous electrode. The membrane-electrode assembly may further include a fourth adhesive layer in contact with the second major surface the ion permeable membrane and the second discontinuous transport protection layer, wherein the fourth adhesive layer adheres the second discontinuous transport protection layer to the ion permeable membrane. The fourth adhesive layer is disposed along the perimeter of the membrane-electrode assembly

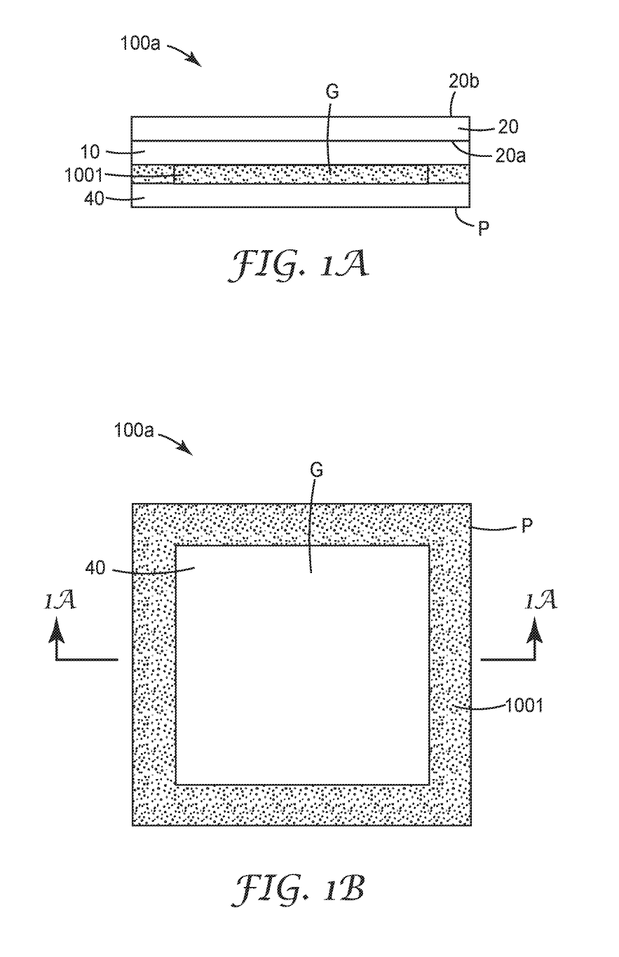

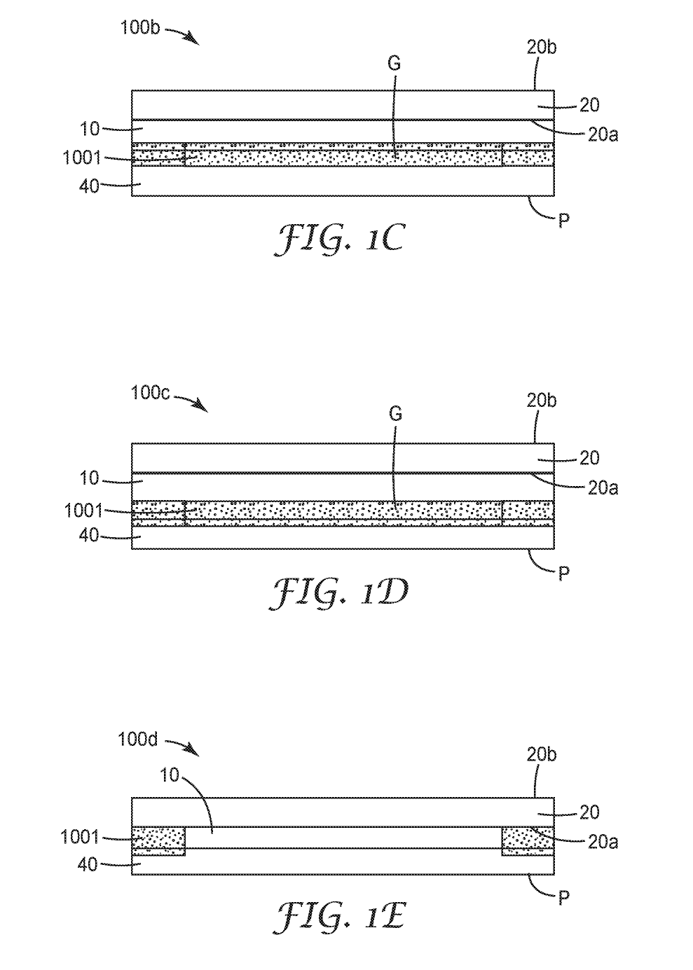

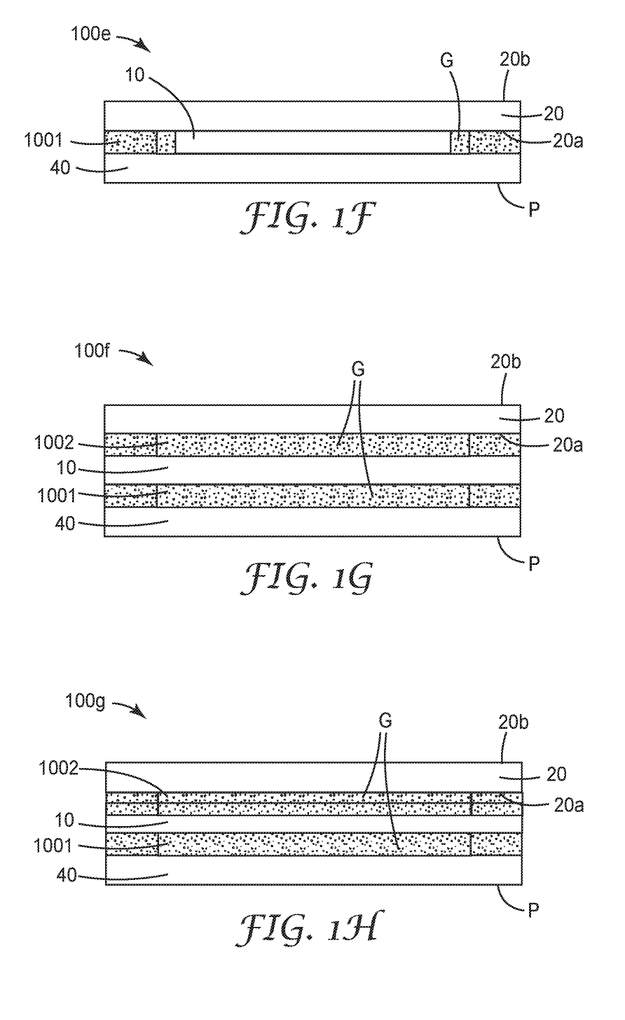

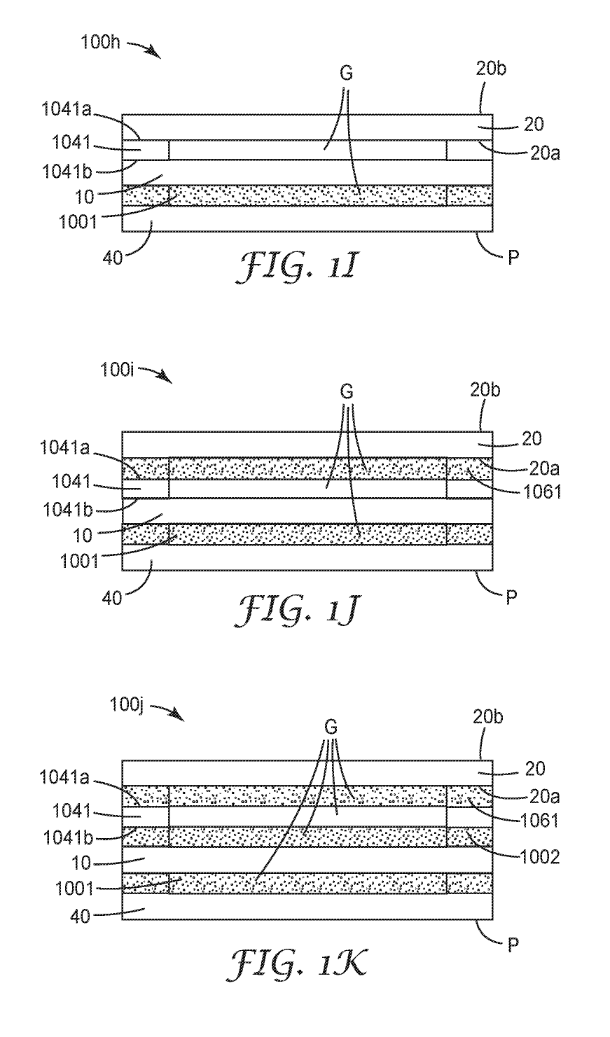

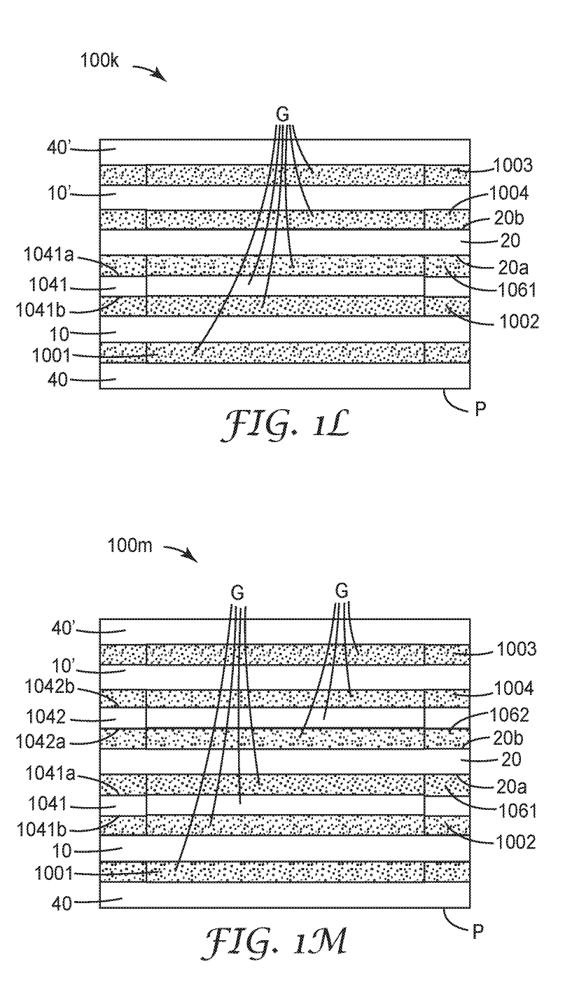

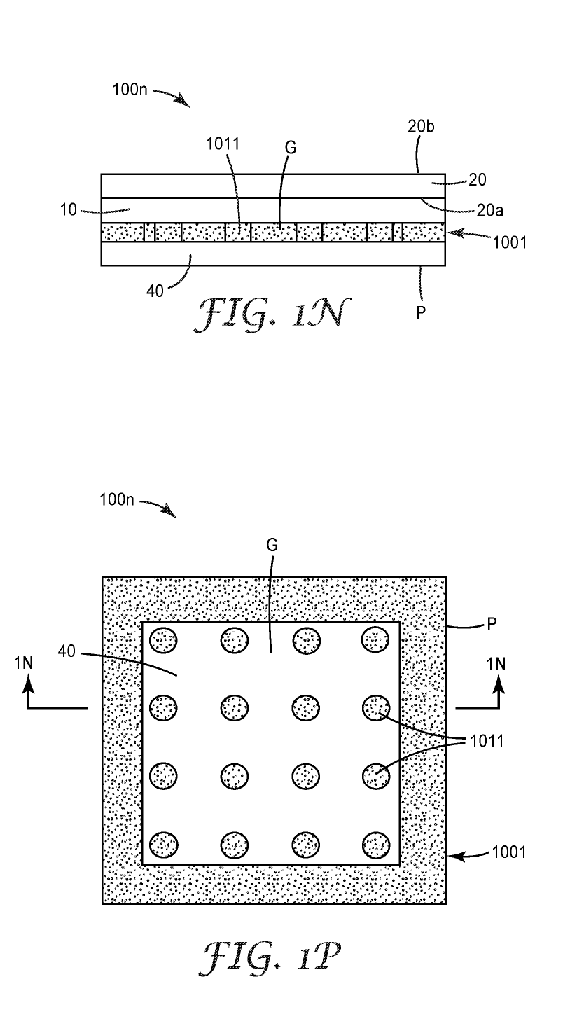

In some embodiments, the first, second third and/or fourth adhesive layer is disposed along the perimeter of the membrane-electrode assembly but does not extend to the peripheral edge of the membrane-electrode assembly. The first, second third and/or fourth adhesive layer may be in the shape of an annulus, i.e. an annular shaped first adhesive layer an annular shaped second adhesive layer, an annular shaped third adhesive layer and/or an annular shaped fourth adhesive layer. The term “annulus” and/or “annular” is generally used to describe a ring shaped object bounded by two concentric circles. However, in the present disclosure, the term “annulus” and/or “annular” will refer to a ring shaped objected. The shape of the annulus is not particularly limited and may include, but is not limited to, a circle, square, rectangle, triangle, oval and diamond. In some embodiments, the first, second, third and/or fourth adhesive layer may be disposed along the perimeter of the membrane-electrode assembly but do not extend into the center portion of membrane electrode assembly. In some embodiments, the first, second, third and/or fourth adhesive layer is disposed in an annular shaped region along or near the perimeter of the membrane-electrode assembly and the interior of the annular shaped region is free of the first, second, third and/or fourth adhesive layer, respectively. In some embodiments, at least a portion of the first adhesive layer and/or at least a portion of third adhesive layer may be embedded in the first discontinuous transport protection layer and/or second discontinuous transport protection layer, respectively. In some embodiments, substantially the entire first adhesive layer and/or substantially the entire third adhesive layer may be embedded in the first discontinuous transport protection layer and/or second discontinuous transport protection layer, respectively. By “substantially the entire” it is meant that at least 80 percent, at least 90 percent, at least 95 percent at least 99 or even at least 100 percent of the volume of the first adhesive layer is embedded in the indicated layer or layers. In some embodiments, at least a portion of the first adhesive layer and/or at least a portion of third adhesive layer may be embedded in the first discontinuous transport protection layer and the first porous electrode and/or the second discontinuous transport protection layer and the second porous electrode, respectively. In some embodiments, substantially the entire first adhesive layer and/or substantially the entire third adhesive layer, may be embedded in the first discontinuous transport protection layer and the first porous electrode and/or may be embedded in the second discontinuous transport protection layer and the second porous electrode, respectively. The first, second, third and/or fourth adhesive layer may be a continuous adhesive layer, as shown in for example FIG. 1B, first adhesive layer 1001. In some embodiments, the first, second, third and/or fourth adhesive layer may be a discontinuous adhesive layer comprising at least two adhesive regions, a first adhesive region and a second adhesive region, located along the perimeter of the membrane-electrode assembly, wherein the first adhesive region is opposite the second adhesive region, i.e. the first adhesive region is located along a portion of the perimeter opposite the portion of the perimeter where the second adhesive region is located. The membrane-electrode assemblies may be integral structures.

FIGS. 1A through 1P disclose various, non-limiting, embodiments of membrane-electrode assemblies of the present disclosure. FIG. 1A is a schematic cross-sectional side view, through line 1A of FIG. 1B and FIG. 1B is a schematic top view in the plane of adhesive layer 1001, of the exemplary membrane-electrode assembly of FIG. 1A, according to one embodiment of the present disclosure. Membrane-electrode assembly 100a includes a first porous electrode 40; ion permeable membrane 20, having a first major surface 20a and an opposed second major surface 20b; a first discontinuous transport protection layer 10, having a first major surface and a second major surface, disposed between the first porous electrode 40 and the first major surface 20a of the ion permeable membrane 20; and at least one adhesive layer 1001 in contact with the first porous electrode 40 and at least one of the first discontinuous transport protection layer 10 and the ion permeable membrane 20. In this exemplary embodiment, the at least one adhesive layer 1001 is in contact with the first porous electrode 40 and the first discontinuous transport protection layer 10. The first porous electrode 40 and first discontinuous transport protection layer 10, without the presence of the first adhesive layer 1001, are not an integral structure. First adhesive layer 1001 is disposed along the perimeter, P, of the membrane-electrode assembly. In this exemplary embodiment, a gap, G, is present in the central region of the adhesive layer, as the adhesive layer is in the shape of an annulus. In this embodiment, the first adhesive layer is not embedded, e.g. is not at least partially embedded, in either the discontinuous transport protection layer or porous electrode.

In some embodiments, the first adhesive layer may be at least partially embedded in the discontinuous transport protection layer. FIG. 1C shows membrane-electrode assembly 100b. Membrane-electrode assembly 100b is similar to membrane-electrode assembly 100a, as previously described, except first adhesive layer 1001 is at least partially embedded in discontinuous transport protection layer 10, e.g. a portion of first adhesive layer 1001 is at least partially embedded in discontinuous transport protection layer 10.

In some embodiments, the first adhesive layer may be at least partially embedded in the first porous electrode. FIG. 1D shows membrane-electrode assembly 100c. Membrane-electrode assembly 100c is similar to membrane-electrode assembly 100a, as previously described, except first adhesive layer 1001 is at least partially embedded in first porous electrode 40, e.g. a portion of first adhesive layer 1001 is at least partially embedded in first porous electrode 40. In some embodiments, the first adhesive layer may be at least partially embedded in the first discontinuous transport protection layer and may be at least partially embedded in the first porous electrode, e.g. a portion of the first adhesive layer is at least partially embedded in the first discontinuous transport protection layer and a portion of the first adhesive layer is at least partially embedded in the first porous electrode.

With respect to exemplary embodiments, such as those shown in FIGS. 1A-1D, the discontinuous transport protection layer and ion permeable membrane may be an integral structure, facilitating the formation of a membrane-electrode assembly having an integral structure or, as will be described below, a second adhesive layer may be used to adhere the ion permeable membrane to the first discontinuous transport protection layer facilitating the formation of a membrane-electrode assembly having an integral structure.

In some embodiments, substantially the entire first adhesive layer may be embedded in the discontinuous transport protection layer and/or first porous electrode. By “substantially the entire” it is meant that at least 80 percent, at least 90 percent, at least 95 percent at least 99 or even at least 100 percent of the volume of the first adhesive layer is embedded in the indicated layer or layers. Additionally, in some embodiments, the first adhesive layer adheres the first discontinuous transport protection layer and the first porous electrode to the ion permeable membrane. FIG. 1E shows membrane-electrode assembly 100d. Membrane-electrode assembly 100d is similar to membrane-electrode assembly 100a, as previously described, except substantially the entire first adhesive layer 1001 is embedded in first discontinuous transport protection layer 10 and first porous electrode 40. In this exemplary embodiment, first adhesive layer 1001 is embedded throughout the entire thickness of first discontinuous transport protection layer 10 and contacts the first major surface 20a of ion permeable membrane 20 and first adhesive layer 1001 is partially embedded in porous electrode 40. As such, the first adhesive layer may adhere the first discontinuous transport protection layer to both the ion permeable membrane and the first porous electrode, forming a membrane-electrode assembly that is an integral structure. With respect to FIG. 1E, for example, in order to form an integral structure, it is not necessary that the first adhesive layer be partially embedded in the first porous electrode, as the first adhesive layer may adhere to the surface of the first porous electrode and still form an integral structure.

In some embodiments, the first adhesive layer adheres the first porous electrode to the ion permeable membrane. FIG. 1F shows membrane-electrode assembly 100e. Membrane-electrode assembly 100e is similar to membrane-electrode assembly 100a, as previously described, except first discontinuous transport protection layer 10 has been sized to fit within the central portion of first adhesive layer 1001, i.e. sized to fit within gap, G, of FIG. 1A. In this exemplary embodiment, first adhesive layer 1001 adheres first porous electrode 40 to the first major surface 20a of ion permeable membrane 20, thereby forming membrane-electrode assembly 100e which is an integral structure. First discontinuous transport protection layer 10 is contained in gap, G, and is part of the integral structure of membrane-electrode assembly 100e.

The membrane-electrode assemblies of the present disclosure may further include a second adhesive layer in contact with the first major surface of the ion permeable membrane and the first discontinuous transport protection layer, wherein the second adhesive layer adheres the first discontinuous transport protection layer to the ion permeable membrane and wherein the second adhesive layer is disposed along the perimeter, P, of the membrane-electrode assembly. In some embodiments, the second adhesive layer is at least partially embedded in the first discontinuous transport protection layer. FIG. 1G shows membrane-electrode assembly 100f. Membrane-electrode assembly 100f is similar to membrane-electrode assembly 100a, as previously described, except it further includes a second adhesive layer 1002. Second adhesive layer 1002 is in contact with the first major surface 20a of ion permeable membrane 20 and the first discontinuous transport protection layer 10. Second adhesive layer 1002 adheres first discontinuous transport protection layer 10 to ion permeable membrane 20. Second adhesive layer 1002 is disposed along the perimeter, P, of membrane-electrode assembly 100f. In some embodiments, the second adhesive layer is in the shape of an annulus. In some embodiments, the second adhesive layer may be at least partially embedded in the discontinuous transport protection layer, e.g. a portion of the first adhesive layer may be at least partially embedded in the discontinuous transport protection layer. In this exemplary embodiment, gaps, G, are present in adhesive layers 1001 and 1002.

FIG. 1H shows membrane-electrode assembly 100g. Membrane-electrode assembly 100g is similar to membrane-electrode assembly 100f, as previously described, except second adhesive layer 1002 is at least partially embedded in discontinuous transport protection layer 10, e.g. a portion of the second adhesive layer 1002 is at least partially embedded in discontinuous transport protection layer 10. In this exemplary embodiment, gaps, G, are present in adhesive layers 1001 and 1002. Similar to FIGS. 1D and 1E, in some embodiments, first adhesive layer 1001 may be at least partially embedded in discontinuous transport protection layer 10 and/or may be at least partially embedded in first porous electrode 40, e.g. a portion of the first adhesive layer 1001 may be at least partially embedded in discontinuous transport protection layer 10 and/or a portion of first adhesive layer 10 may be at least partially embedded in first porous electrode 40. Use of the second adhesive layer may facilitate forming a membrane-electrode assembly having an integral structure, but is not required. As has previously been shown, a single adhesive layer may be used to form a membrane-electrode assembly that is an integral structure. The second adhesive layer may be a continuous adhesive layer or a discontinuous adhesive layer.

The membrane-electrode assemblies of the present disclosure may further include a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus. FIG. 1I shows membrane-electrode assembly 100h. Membrane-electrode assembly 100h is similar to membrane-electrode assembly 100a, as previously described, except, membrane-electrode assembly 100h further includes first gasket 1041, having a first major surface 1041a and a second major surface 1041b, disposed between the ion permeable membrane 20 and at least one of first discontinuous transport protection layer 10 and first porous electrode 40. First gasket 1041 is disposed along the perimeter, P, of the membrane-electrode assembly 100h and first gasket 1041 is in the shape of an annulus. In this exemplary embodiment, first gasket 1041 is disposed between both first discontinuous transport protection layer 10 and first porous electrode 40, being adjacent to first discontinuous transport protection layer 10. First adhesive layer 1001 adheres first discontinuous transport protection layer 10 to first porous electrode 40. The configuration of first discontinuous transport protection layer 10, first adhesive layer 1001 and first porous electrode 40 may be any of those previously described, for example, the configurations described in FIGS. 1A-1F. For example, in another embodiment, similar to FIG. 1F, first discontinuous transport protection layer 10 may be sized to fit within the central portion of first adhesive layer 1001, i.e. sized to fit within gap, G, and first gasket 1041 would then be disposed between ion permeable membrane 20 and first porous electrode 40. First adhesive layer 1001 would then adhere first porous electrode 40 to first gasket 1041. Other adhesive layers may be used to facilitate the formation of a membrane-electrode assembly which is an integral structure, e.g. one or more adhesive layers may be used to adhere the ion permeable membrane to the gasket, e.g. the first gasket, and/or adhere the gasket, e.g. first gasket, to the discontinuous transport protection layer, e.g. the first discontinuous transport protection layer. However, in some embodiments, this may not be required, as the ion permeable membrane and gasket, e.g. first gasket, may be an integral structure; the gasket, e.g. first gasket, and the discontinuous transport protection layer, e.g. first discontinuous transport protection layer, may be an integral structure; or the ion permeable membrane, gasket, e.g. first gasket, and discontinuous transport protection layer, e.g. first discontinuous transport protection layer, may be an integral structure. Gaps, G, may exist in the gasket and the first adhesive layer.

The membrane-electrode assemblies of the present disclosure, which include a gasket, e.g. a first gasket, may further include at least one of a gasket adhesive layer, e.g. a first gasket adhesive layer, in contact with the first major surface of the gasket, e.g. first gasket, and the first major surface of the ion permeable membrane; and a second adhesive layer in contact with the second major surface of the gasket, e.g. first gasket, and the discontinuous transport protection layer, e.g. first discontinuous transport protection layer. In some embodiments, the membrane-electrode assemblies, which include a first gasket, include at least one first gasket adhesive layer in contact with the first major surface of the first gasket and the first major surface of the ion permeable membrane. In some embodiments, the membrane-electrode assemblies, which include a first gasket, include a second adhesive layer in contact with the second major surface of the first gasket and the first discontinuous transport protection layer. In some embodiments, the membrane-electrode assemblies, which include a first gasket, include at least one first gasket adhesive layer in contact with the first major surface of the first gasket and the first major surface of the ion permeable membrane and a second adhesive layer in contact with the second major surface of the first gasket and the first discontinuous transport protection layer. FIG. 1J shows membrane-electrode assembly 100i. Membrane-electrode assembly 100i is similar to membrane-electrode assembly 100h, as previously described, except, membrane-electrode assembly 100i further includes at least one first gasket 1041, having first major surface 1041a and opposed second major surface 1041b, and at least one of a first gasket adhesive layer 1061. First gasket adhesive layer 1061 is in contact with first major surface 1041a of first gasket 1041 and first major surface 20a of ion permeable membrane 20. Gaps, G, may exist in the first gasket, the first gasket adhesive layer and the first adhesive layer.

In another embodiment, FIG. 1K shows membrane-electrode assembly 100j, which is similar to membrane-electrode assembly 100h, as previously described, except, membrane-electrode assembly 100j further includes first gasket adhesive layer 1061, in contact with first major surface 1041a of first gasket 1041 and first major surface 20a of ion permeable membrane 20, and a second adhesive layer 1002 in contact with the second major surface 1041b of first gasket 1041 and the first discontinuous transport protection layer 10. In an alternative embodiment (not shown), first gasket adhesive layer 1061 may be removed from membrane-electrode assembly 100j, producing a membrane-electrode assembly similar to membrane-electrode assembly 100h, except the membrane-assembly would include a second adhesive layer 1002 in contact with the second major surface 1041b of first gasket 1041 and the first discontinuous transport protection layer 10. The gasket adhesive layer, e.g. first gasket adhesive layer, may be a continuous adhesive layer or a discontinuous adhesive layer. Gaps, G, may exist in the first gasket, the first gasket adhesive layer, the first adhesive layer and the second adhesive layer.

The membrane-electrode assemblies of the present disclosure may further include a second porous electrode and a second discontinuous transport protection layer disposed between the second porous electrode and the second major surface of the ion permeable membrane. The membrane-electrode assemblies of the present disclosure that include a second porous electrode and a second discontinuous transport protection layer disposed between the second porous electrode and the second major surface of the ion permeable membrane may further include a third adhesive layer in contact with the second porous electrode and at least one of the second discontinuous transport protection layer and the ion permeable membrane. The third adhesive layer may be disposed along the perimeter of the membrane-electrode assembly. In some embodiments, the second porous electrode and second discontinuous transport protection layer, without the presence of the third adhesive layer, are not an integral structure and the membrane-electrode assembly is an integral structure. In some embodiments, the third adhesive layer may be in contact with at least one of or both the second surface of the ion permeable membrane and the second discontinuous transport protection layer. In some embodiments, the third adhesive layer may be in contact with at least one of or both the second surface of the ion permeable membrane and the second porous electrode. The third adhesive layer may be at least partially embedded in at least one of the second discontinuous transport protection layer and the second porous electrode. In some embodiments, the third adhesive layer adheres the second discontinuous transport protection layer to the second porous electrode. In some embodiments, the third adhesive layer adheres at least one of the second discontinuous transport protection layer and the second porous electrode to the ion permeable membrane. The third adhesive layer may be disposed along the perimeter, P, of the membrane-electrode assembly. The third adhesive layer may be a continuous adhesive layer or a discontinuous adhesive layer. The membrane-electrode assemblies of the present disclosure may further include a fourth adhesive layer in contact with the second major surface of the ion permeable membrane and the second discontinuous transport protection layer. The fourth adhesive layer may adhere the second discontinuous transport protection layer to the ion permeable membrane. The fourth adhesive layer may be disposed along the perimeter, P, of the membrane-electrode assembly. In some embodiments, the fourth adhesive layer is at least partially embedded in the second discontinuous transport protection layer. The fourth adhesive layer may be a continuous adhesive layer or a discontinuous adhesive layer.

FIG. 1L shows membrane-electrode assembly 100k. Membrane-electrode assembly 100k is similar to membrane-electrode assembly 100j, as previously described, except membrane-electrode 100k further includes a second porous electrode 40′ and a second discontinuous transport protection layer 10′ disposed between the second porous electrode 40′ and the second major surface 20b of the ion permeable membrane 20. The membrane-electrode assembly may further includes a third adhesive layer 1003 in contact with the second porous electrode. In some embodiments, third adhesive layer 1003 may be in contact with at least one of or both of the second discontinuous transport protection layer 10′ and second surface 20b of the ion permeable membrane 20. In some embodiments, third adhesive layer 1003 may be in contact with at least one of or both second surface 20b of ion permeable membrane 20 and second porous electrode 40′. Third adhesive layer 1003 may be at least partially embedded in at least one of second discontinuous transport protection layer 10′ and second porous electrode 40′. In some embodiments, third adhesive layer 1003 adheres second discontinuous transport protection layer 10′ to second porous electrode 40′. In some embodiments, third adhesive layer 1003 adheres at least one of second discontinuous transport protection layer 10′ and second porous electrode 40′ to ion permeable membrane 20. Third adhesive layer 1003 may be disposed along the perimeter, P, of the membrane-electrode assembly 100k. The membrane-electrode assemblies of the present disclosure that include a second porous electrode, a second discontinuous transport protection layer disposed between the second porous electrode and the second major surface of the ion permeable membrane and a third adhesive layer in contact with the second porous electrode and at least one of the second discontinuous transport protection layer and the ion permeable membrane may, optionally, further include a fourth adhesive layer 1004 in contact with second major surface 20b of ion permeable membrane 20 and second discontinuous transport protection layer 10′. Fourth adhesive layer 1004 may adhere second discontinuous transport protection layer 10′ to ion permeable membrane 20. Fourth adhesive layer 1004 is disposed along the perimeter, P, of membrane-electrode assembly 100k. In some embodiments, fourth adhesive layer 1004 is at least partially embedded in second discontinuous transport protection layer 10′. In some embodiments, fourth adhesive layer 1004 may adhere the second discontinuous transport protection layer 10′ to ion permeable membrane 20. In some embodiments, fourth adhesive layer 1004 is at least partially embedded in second discontinuous transport protection layer 10′. Fourth adhesive layer 1004 may be a continuous adhesive layer or a discontinuous adhesive layer. Gaps, G, may exist in the third and/or fourth adhesive layers.

The membrane-electrode assemblies of the present disclosure that include a second porous electrode and a second discontinuous transport protection layer disposed between the second porous electrode and the second major surface of the ion permeable membrane may further include a second gasket, having a first major surface and a second major surface, disposed between the ion permeable membrane and at least one of the second discontinuous transport protection layer and the second porous electrode. The second gasket is disposed along the perimeter of the membrane-electrode assembly and the second gasket is in the shape of an annulus. These membrane-electrode assemblies may further include at least one of a second gasket adhesive layer in contact with the first major surface of the second gasket and the second major surface of the ion permeable membrane and a fourth adhesive layer in contact with the second major surface of the second gasket and the second discontinuous transport protection layer. FIG. 1M shows membrane-electrode assembly 100m. Membrane-electrode assembly 100m is similar to membrane-electrode assembly 100k, as previously described, except membrane-electrode 100m further includes second gasket 1042, having a first major surface 1042a and a second major surface 1042b, disposed between ion permeable membrane 20 and at least one of second discontinuous transport protection layer 10′ and second porous electrode 40′. In this exemplary embodiment, membrane-electrode assembly 100m includes second gasket adhesive layer 1062 in contact with first major surface 1042a of second gasket 1042 and second major surface 20b of ion permeable membrane 20. Second gasket 1042 is disposed along the perimeter, P, of membrane-electrode assembly 100m and second gasket 1042 is in the shape of an annulus. Membrane-electrode assembly 100m may further include fourth adhesive layer 1004 in contact with second major surface 1042b of second gasket 1042 and second discontinuous transport protection layer 10′. Gaps, G, may exist in the second gasket and second gasket adhesive layer.

With respect to membrane-electrode assembly configurations (e.g. number and types of layers, number of adhesive layers, adhesive layers embedded in other layers, etc.) involving an ion permeable membrane, a second porous electrode, a second discontinuous transport protection layer, a third adhesive layer, a fourth adhesive layer, a second gasket and/or a second gasket adhesive layer, any of the membrane-electrode assembly configurations previously described herein which include an ion permeable membrane, a first porous electrode, a first discontinuous transport protection layer, a first adhesive layer, a second adhesive layer, a first gasket and/or a first gasket adhesive layer, for example the configurations of membrane-electrode assemblies shown in FIGS. 1A-1K, may be employed. In these comparisons, the second porous electrode is analogous to the first porous electrode, the second discontinuous transport protection layer is analogous to the first discontinuous transport protection layer, the first adhesive layer is analogous to the third adhesive layer, the fourth adhesive layer is analogous to the second adhesive layer, the second gasket is analogous to the first gasket and the second gasket adhesive layer is analogous to the first gasket adhesive layer.

In another embodiment, the present disclosure provides a membrane-electrode assembly including a first porous electrode, an ion permeable membrane, having a first major surface and an opposed second major surface, a first discontinuous transport protection-layer, disposed between the first porous electrode and the ion permeable membrane; and a first adhesive layer in contact with the first porous electrode and at least one of the first discontinuous transport protection layer and the ion permeable membrane, wherein the first adhesive layer is a plurality of first adhesive regions disposed at least within the interior of the membrane-electrode assembly and the area of the first plurality of adhesive regions, in the plane of the membrane electrode assembly, is less than at least 50 percent of the projected area of the membrane electrode assembly. The first porous electrode and first discontinuous transport protection layer, without the presence of the first adhesive layer, are not an integral structure and the membrane-electrode assembly is an integral structure. In some embodiments, the first adhesive layer adheres the first porous electrode to the ion permeable membrane. The membrane electrode assembly may further include a second adhesive layer in contact with the first major surface of the ion permeable membrane and the first discontinuous transport protection layer. The second adhesive layer adheres the first discontinuous transport protection layer to the ion permeable membrane. The second adhesive layer may be disposed along the perimeter of the membrane-electrode assembly. The second adhesive layer may be a plurality of second adhesive regions disposed at least within the interior of the membrane-electrode assembly and the area of the second plurality of adhesive regions, in the plane of the membrane electrode assembly, is less than at least 50 percent of the projected area of the membrane electrode assembly. In some embodiments, the second adhesive layer is at least partially embedded in the first discontinuous transport protection layer. The membrane-electrode assembly may further comprise a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus. In some embodiments, the first gasket may be disposed between the ion permeable membrane and the first discontinuous transport protection layer. In some embodiments, the first gasket may be disposed between the ion permeable membrane and the first porous electrode. In one particular embodiment, the first discontinuous transport protection layer may be sized to fit within the central portion of the first gasket, i.e. sized to fit within gap, G, of the first gasket. Hence, the first gasket is then disposed between the ion permeable membrane and the first porous electrode. Additionally, the first adhesive layer may then adhere the first porous electrode to the first surface of the ion permeable membrane, as the first adhesive may be embedded through the entire thickness of the first porous protection layer and contacts the ion permeable membrane and porous electrode, forming a membrane-electrode assembly having an integral structure using a single adhesive layer. The membrane-electrode assembly, including a first gasket may further include at least one of a first gasket adhesive layer in contact with the first major surface of the first gasket and the first major surface of the ion permeable membrane; and a second adhesive layer in contact with the second major surface of the first gasket and the first discontinuous transport protection layer.

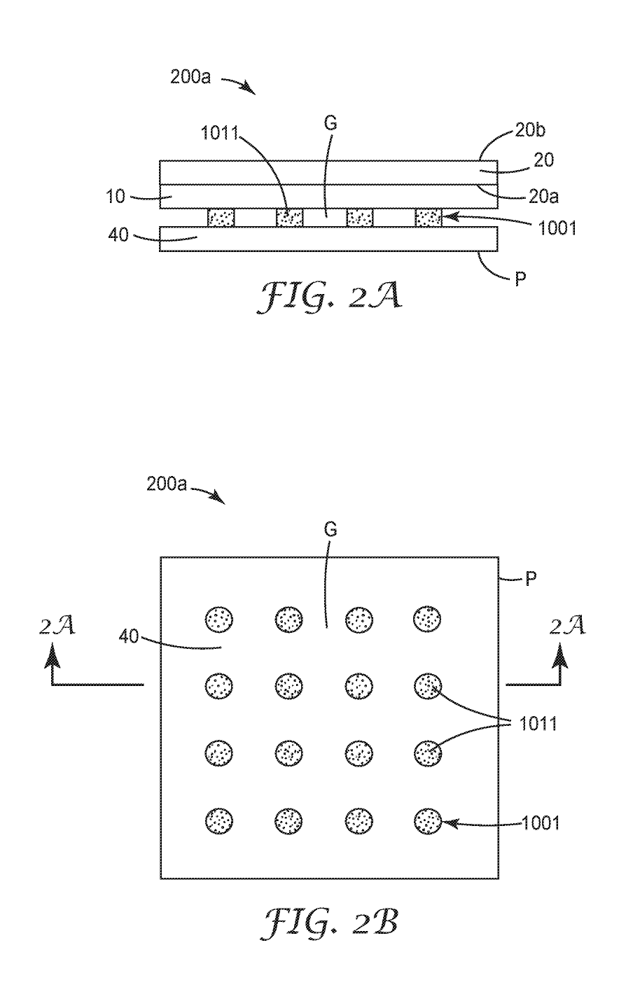

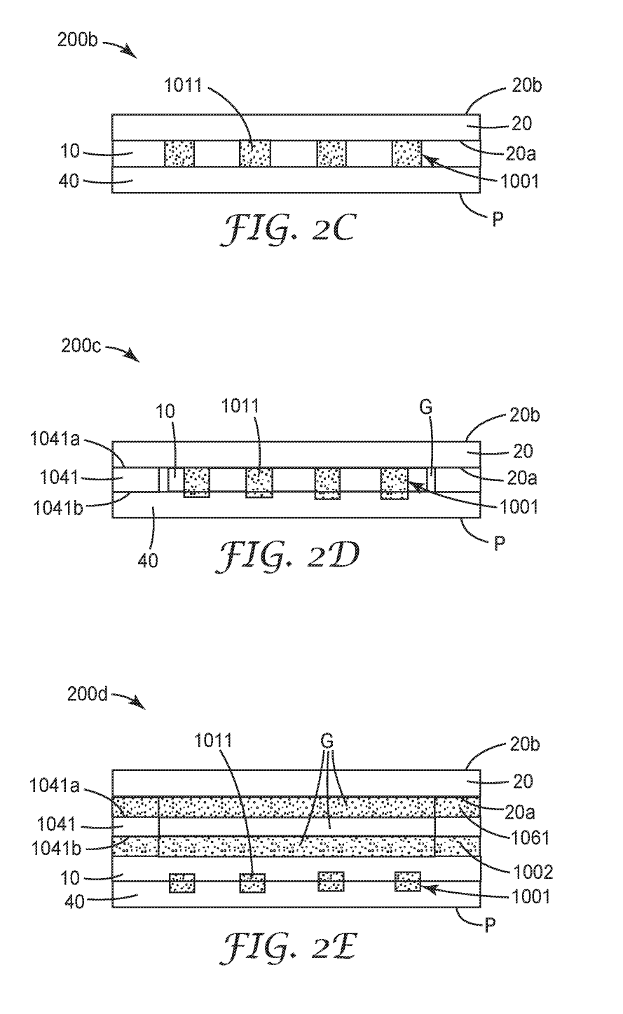

FIG. 2A is a schematic cross-sectional side view, through line 2A of FIG. 2B, of an exemplary membrane-electrode assembly according to one exemplary embodiment of the present disclosure. FIG. 2A shows membrane-electrode assembly 200a, including discontinuous transport protection layer 10, porous electrode 40, ion permeable membrane 20 having a first surface 20a and an opposed second surface 20b; and first adhesive layer 1001 disposed between porous electrode 40 and discontinuous transport protection layer 10. First adhesive layer 1001 includes a plurality of first adhesive regions 1011 disposed within the interior of the membrane-electrode assembly 200a, wherein the area of the first plurality of adhesive regions, in the plane of the membrane electrode assembly 200a (total area of the circles shown in FIG. 2B), is less than at least 50 percent of the projected area of the membrane electrode assembly (area of the large square shown in FIG. 2B). In this exemplary embodiment, first adhesive layer 1001 is in contact with both the first porous electrode 40 and discontinuous transport protection layer 10. First porous electrode 40 and first discontinuous transport protection layer 10, without the presence of first adhesive layer 1001, are not an integral structure. Membrane-electrode assembly 200a is an integral structure. The first discontinuous transport protection layer and ion permeable membrane may be an integral structure, or may be adhered to one another via a second adhesive layer. In FIG. 2A, the first adhesive layer is diagramed as being in contact with the transportation protection layer 10, but not being embedded therein. However, this is not a particular limitation and first adhesive layer 1001 may be embedded through a portion of the thickness of discontinuous transport protection layer 10; through substantially the entire thickness of discontinuous transport protection layer 10 (thereby contacting the first major surface 20a of ion permeable membrane 20); through substantially the entire thickness of discontinuous transport protection layer 10 and partially through the thickness of porous electrode 40 or through substantially the entire thickness of discontinuous transport protection layer 10 and through substantially the entire thickness of porous electrode 40. The phrase “may be embedded through substantially the entire thickness” is meant to include that at least 80 percent, at least 90 percent, at least 95 percent, at least 99 or even at least 100 percent of the thickness of the layer has been embedded with adhesive. FIG. 2B is a schematic top view, in the plane of the adhesive layer, of the exemplary membrane-electrode assembly of FIG. 2A, according to one exemplary embodiment. FIG. 2B shows first adhesive layer 1001, which includes a plurality of first adhesive regions 1011 disposed within the interior of the membrane-electrode assembly 200a.

FIG. 2C shows membrane-electrode assembly 200b. Membrane-electrode assembly 200b is similar to membrane-electrode assembly 200a, as previously described, except first adhesive layer 1001 of membrane-electrode 200b is embedded through substantially the entire thickness of discontinuous transport protection layer 10. In this embodiment, first adhesive layer 1001 adheres first porous electrode 40 to ion permeable membrane 20.

Membrane-electrode assembly 200a may further include a second adhesive layer analogous to that described in FIGS. 1G and 1H, for example. In some embodiments, the second adhesive layer is a second plurality of adhesive regions disposed within the interior of the membrane-electrode assembly and wherein the area of the second plurality of adhesive regions, in the plane of the membrane electrode assembly, is less than at least 50 percent of the projected area of the membrane electrode assembly. In some embodiments, the area of the second plurality of adhesive regions, in the plane of the membrane electrode assembly, is less than at least 50 percent, less than at least 40 percent less than at least 30 percent, less than at least 20 percent, less than at least 10 percent or even less than at least 5 percent of the projected area of the membrane electrode assembly. When the first and/or second adhesive layer includes a plurality of adhesive regions disposed within the interior of the membrane-electrode assembly, the shape of the adhesive regions of the first and second adhesive layer is not particularly limited and may include, but are not limited to, cubes, rectangular solids, cylinders, spheres, spheroids, pyramids, truncated pyramids, cones and the like. The adhesive regions may be discrete lines, e.g. rectangular solid lines, cylindrical lines and the like.

Membrane-electrode assemblies 200a and 200c, for example, may further include a first gasket layer 1041 analogous to that described in FIGS. 1I-1k, for example. FIG. 2D shows membrane-electrode assembly 200c. Membrane-electrode assembly 200c is similar to membrane-electrode assembly 200a, as previously described, except membrane-electrode assembly 200c further includes a first gasket 1041, having a first major surface 1041a and a second major surface 1041b; first discontinuous transport protection layer 10 is sized to fit within the central portion of the first gasket 1041, i.e. sized to fit within gap, G, of first gasket 1041; and first adhesive layer 1001 is embedded through substantially the entire thickness of discontinuous transport protection layer 10 and partially through the thickness of porous electrode 40. In this exemplary embodiment, a single adhesive layer is used to form a membrane electrode assembly having an integral structure.

Membrane-electrode assemblies that include a first gasket layer, for example membrane-electrode assembly 200c, may further include a first gasket adhesive layer 1061, analogous to that described in FIGS. 1J-1M, for example. FIG. 2E shows membrane-electrode assembly 200d. Membrane-electrode assembly 200d includes a first discontinuous transport protection layer 10, porous electrode 40, a ion permeable membrane 20 having a first surface 20a and an opposed second surface 20b, a first adhesive layer 1001 disposed between porous electrode 40 and discontinuous transport protection layer 10. First adhesive layer 1001 includes a plurality of first adhesive regions 1011 disposed within the interior of the membrane-electrode assembly 200a, wherein the area of the first plurality of adhesive regions, in the plane of the membrane electrode assembly 200d, is less than at least 50 percent of the projected area of the membrane electrode assembly 200d. In this exemplary embodiment, first adhesive layer 1001 is partially embedded in both first porous electrode 40 and discontinuous transport protection layer 10. Although there is no gap between the first porous electrode and the discontinuous transport protection layer, the first adhesive layer is still considered to be disposed between the two layers as there is at least a portion of the first adhesive located at the interface between the porous electrode and first discontinuous transport protection layer. Membrane-electrode assembly 200d further includes a first gasket 1041, having a first major surface 1041a and a second major surface 1041b; a second adhesive layer 1002 disposed between the first gasket 1041 and at least one of the first discontinuous transport protection layer 10 and the first porous electrode 40; and a first gasket adhesive layer 1061 disposed between the ion permeable membrane 20 and the first gasket 1041. First gasket adhesive layer 1061 is in contact with first major surface 1041a of first gasket 1041 and first major surface 20a of ion permeable membrane 20; and second adhesive layer 1002 in contact with the second major surface 1041b of first gasket 1041 and the first discontinuous transport protection layer 10. First porous electrode 40 and first discontinuous transport protection layer 10, without the presence of first adhesive layer 1001, are not an integral structure. Membrane-electrode assembly 200d is an integral structure.

In some embodiments, at least one of the first adhesive layer, second adhesive layer, third adhesive layer and fourth adhesive layer, may be disposed along the perimeter of the membrane-electrode assembly and may also include a plurality of adhesive regions (first, second, third and fourth adhesive regions corresponding to first, second, third and fourth adhesive layers, respectively) disposed at least within the interior of the membrane-electrode assembly and the area of the plurality of adhesive regions, in the plane of the membrane electrode assembly, is less than at least 50 percent of the projected area of the membrane electrode assembly. FIG. 1N is a schematic cross-sectional side view, through line 1N of FIG. 1P, of an exemplary membrane-electrode assembly and FIG. 1P is a schematic top view in the plane of the adhesive layer, of the exemplary membrane-electrode assembly of FIG. 1N. FIGS. 1N and 1P show membrane-electrode assembly 100n which includes a first porous electrode 40; ion permeable membrane 20, having a first major surface 20a and an opposed second major surface 20b; a first discontinuous transport protection layer 10, having a first major surface and a second major surface, disposed between the first porous electrode 40 and the first major surface 20a of the ion permeable membrane 20; and at least one adhesive layer 1001 in contact with the first porous electrode 40 and at least one of the first discontinuous transport protection layer 10 and the ion permeable membrane 20. In this exemplary embodiment, the at least one adhesive layer 1001 is in contact with the first porous electrode 40 and the first discontinuous transport protection layer 10. The first porous electrode 40 and first discontinuous transport protection layer 10, without the presence of the first adhesive layer 1001, are not an integral structure. First adhesive layer 1001 is disposed along the perimeter, P, of the membrane-electrode assembly and also includes a plurality of first adhesive regions 1011 disposed within the interior of the membrane-electrode assembly 100n, wherein the area of the first plurality of adhesive regions, in the plane of the membrane electrode assembly 100n (total area of the circles shown in FIG. 1P), is less than at least 50 percent of the projected area of the membrane electrode assembly (area of the large square shown in FIG. 2P). In this exemplary embodiment, a gap, G, is still present in the central region of the adhesive layer, between the plurality of first adhesive regions. In this embodiment, the first adhesive layer is not embedded, e.g. is not at least partially embedded, in either the discontinuous transport protection layer or porous electrode. Any of the previously disclosed membrane-electrode assemblies may include one or more adhesive layers that include adhesive disposed along the perimeter, P, of the membrane-electrode assembly and also includes a plurality of adhesive regions disposed within the interior of the membrane-electrode assembly, wherein the area of the plurality of adhesive regions, in the plane of the membrane electrode assembly is less than at least 50 percent of the projected area of the membrane electrode assembly. The combination of adhesive being disposed along both the perimeter and in a portion of the interior region of the membrane-electrode assembly may provide improved dimensional stability of the membrane-electrode assembly.

Throughout this disclosure, various components of the membrane-electrode assembly, e.g. adhesive layers and gasket layers, have included a “gap”. During actual use, within an electrochemical cell or liquid flow battery, one or more of the gaps, up to including all the gaps, may be decreased in thickness or eliminated completely, due to the forces, e.g. compression forces, applied to the membrane-electrode assembly during the assembly of an electrochemical cell or liquid flow battery.

The membrane-electrode assemblies of the present disclosure include a discontinuous transport protection layer. By “discontinuous” it is meant that the transport protection layer includes at least one open region and/or a plurality of open regions which allow fluid communication between the first major surface and second major surface of the discontinuous transport protection layer. The discontinuous transport protection layer may include at least one of a mesh structure, a woven structure, and a nonwoven structure.

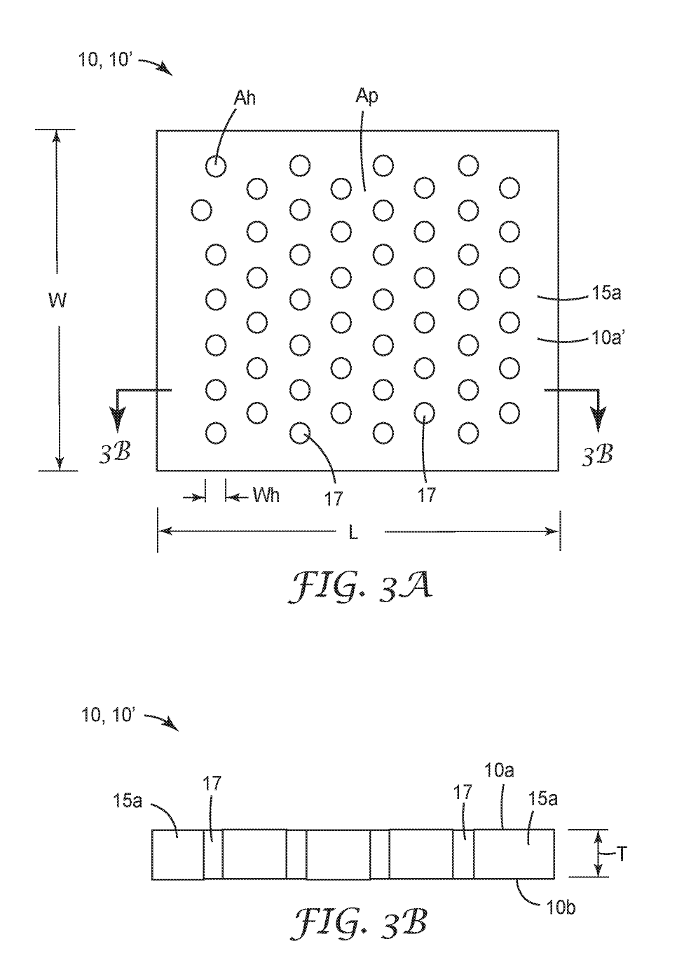

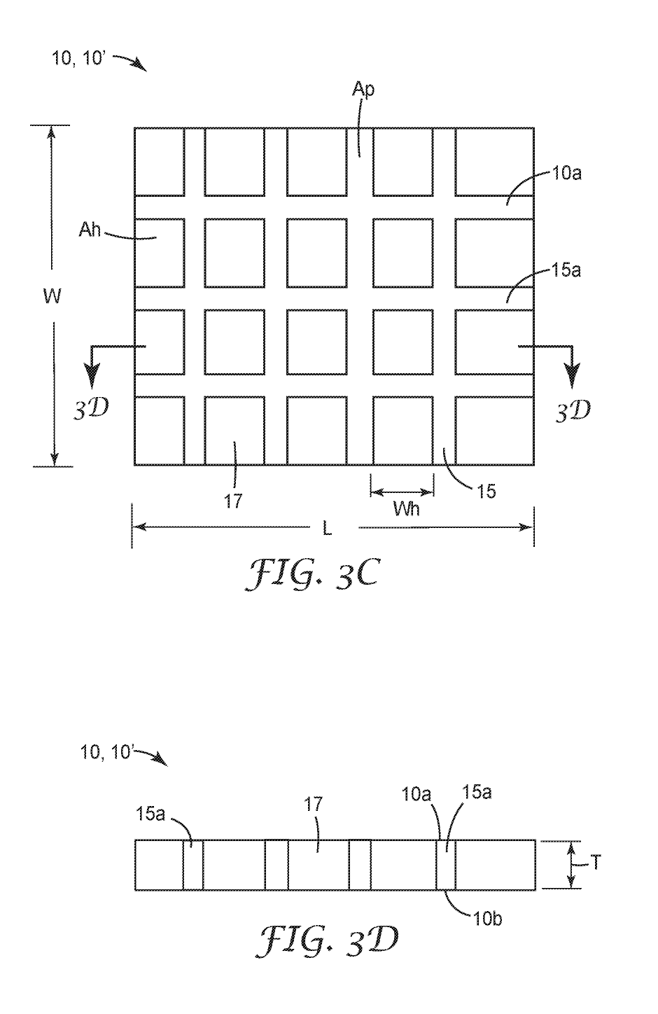

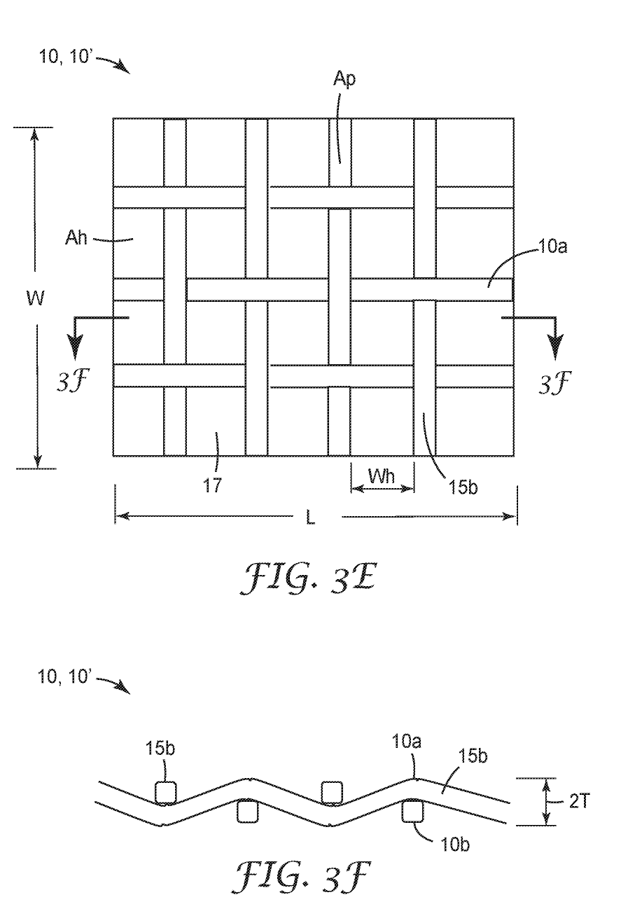

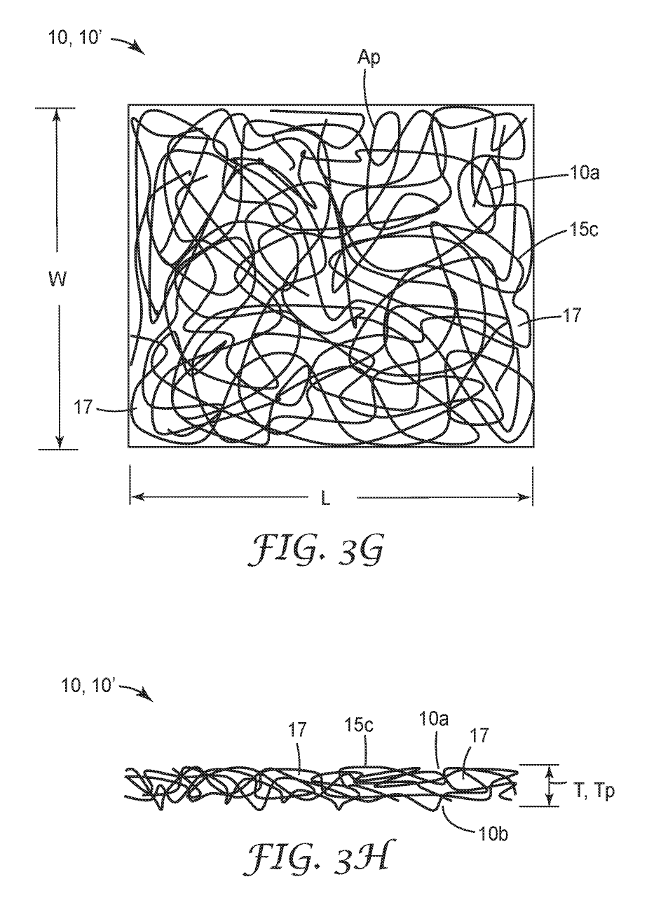

FIG. 3A is a schematic top view and FIG. 3B is the corresponding schematic cross-sectional side view, through line 3B of FIG. 3A, of an exemplary discontinuous transport protection layer according to one embodiment of the present disclosure. In this exemplary embodiment, discontinuous transport protection layer 10 and/or 10′ is a mesh structure 15a that includes open regions 17 (e.g. a plurality of through holes, circular shaped cylinders with the axis of the cylinders substantially normal to first major surface 10a and an opposed second major surface 10b of discontinuous transport protection layer, the cylinders being in a hexagonal array pattern), having a width, Wh (e.g. diameter), a thickness, T, and an area, Ah (equivalent to π[Wh/2]²). The total area of the open regions 17, e.g. total area of the through holes, is n×Ah, where n is the number of open regions, e.g. the number of through holes. The discontinuous transport protection layer has a length, L, a width W and a thickness T. The area of the first major surface 10a of the discontinuous transport protection layer is Ap. The projected area of discontinuous transport protection layer is L×W.

FIG. 3C is a schematic top view and FIG. 3D is the corresponding schematic cross-sectional side view, through line 3D of FIG. 3C, of an exemplary discontinuous transport protection layer according to one embodiment of the present disclosure. In this exemplary embodiment, discontinuous transport protection layer 10 and/or 10′ is a mesh structure 15a that includes open regions 17 (e.g. a plurality of through-holes, square shaped cylinders with the axis of the cylinder substantially normal to first major surface 10a and opposed second major surface 10b of the discontinuous transport protection layer, the cylinders being in a square grid array pattern), having a width, Wh, a thickness, T, and an area, Ah. The total area of the open regions 17, e.g. total area of the through holes, is n×Ah, where n is the number of open regions, e.g. the number of through holes. The discontinuous transport protection layer has a length, L, a width W and a thickness T. The area of the first major surface 10a of discontinuous transport protection layer is Ap. The projected area of discontinuous transport protection layer is L×W.

FIG. 3E is a schematic top view and FIG. 3F is the corresponding schematic cross-sectional side view, through line 3F of FIG. 3E, of an exemplary discontinuous transport protection layer according to one embodiment of the present disclosure. In this exemplary embodiment, discontinuous transport protection layer 10 and/or 10′ is a woven structure 15b that includes open regions 17 (e.g. a plurality of through-holes, square shaped cylinders with the axis of the cylinder substantially normal to first major surface 10a and opposed second major surface 10b of the discontinuous transport protection layer, the cylinders being in a square grid array pattern), having a width, Wh, a thickness, 2T (assuming the warp and weft fiber have the same thickness, T, if not, the thickness of the discontinuous transport protection layer may be taken as the sum of the thickness of the warp and weft fibers) and an area, Ah. Note that in this particular embodiments, the height of the open regions may be set equivalent to the sum of the thickness of the warp and weft fiber comprising woven structure 15b. The total area of the open regions 17, e.g. total area of the holes, is n×Ah, where n is the number of open regions, e.g. the number of holes. The discontinuous transport protection layer has a length, L, a width W and a thickness 2T. The area of the first major surface 10a of discontinuous transport protection layer is Ap. The projected area of discontinuous transport protection layer is L×W.

FIG. 3G is a schematic top view and FIG. 3H is the corresponding schematic cross-sectional side view, of an exemplary discontinuous transport protection layer according to one embodiment of the present disclosure. In this exemplary embodiment, discontinuous transport protection layer 10 and/or 10′, having a first major surface 10a and opposed second major surface 10b, is a nonwoven structure 15c that includes open regions 17. The thickness of the discontinuous transport protection layer is T, which may be the same as the thickness, Tp, of the nonwoven structure. Due to its random structure, cross-sectional area, Ap, of a nonwoven is somewhat ambiguous to measure, subsequently, a calculated value may be used. An average value for the cross-sectional area, Ap, of a nonwoven may be calculated from the following equation:

Ap=Mp/(Dp×Tp)

where,

Mp is the mass of the polymer of the nonwoven (within the given area),

Dp is the density of the polymer used to form the nonwoven,

Tp is the thickness of the nonwoven (within the given area).

If the nonwoven includes multiple fiber types, the density Dp will be based on the average density of the fibers making up the nonwoven, adjusted for their mass fraction present in the nonwoven. Dp may also be measured using known techniques in the art. If the thickness, Tp, is not uniform, an average value for the thickness may be used. The discontinuous transport protection layer has a length, L, a width W and a thickness T (the thickness of the discontinuous transport protection layer, T, equals the thickness of the nonwoven, Tp). The projected area of discontinuous transport protection layer is L×W.

The above equation may be generalized to calculate the average value of the cross-sectional area, Ap, of any discontinuous transport protection layer of the present disclosure with Mp being the mass of the polymer of the discontinuous transport protection layer, Dp being the density of the polymer of the discontinuous transport protection layer and Tp being the thickness of the discontinuous transport protection layer. Dp may be measured using known techniques in the art. If the thickness, Tp, is not uniform, an average value for the thickness may be used. In some embodiments, Ap may be the calculated average value for the cross-sectional area: Ap=Mp/(Dp×Tp), with the parameters as defined above.

The discontinuous transport protection layers of the present disclosure may include at least one of a polymer and a ceramic.

The discontinuous transport protection layer may include polymer. The polymer of the discontinuous transport protection layer is not particularly limited. However, in order to ensure long term stability of the polymer in the anolyte and/or catholyte liquids it may be exposed to during use, the polymer of the discontinuous transport protection layer may be selected to have good chemical resistance to the anolyte and/or catholyte, including the associated solvent, oxidizing/reducing active species, salts and/or other additives included therein. In some embodiments, the polymer of the discontinuous transport protection layer may include at least one of a thermoplastic and thermoset. In some embodiments, the polymer of the discontinuous transport protection layer may include a thermoplastic. In some embodiments, the polymer of the discontinuous transport protection layer may include a thermoset. In some embodiments, the polymer of the discontinuous transport protection layer may consists essentially of a thermoplastic. In some embodiments, the polymer of the discontinuous transport protection layer may consists essentially of a thermoset. Thermoplastics may include thermoplastic elastomers. A thermoset may include a B-stage thermoset, e.g. a B-stage thermoset after final cure. In some embodiments, the polymer of the discontinuous transport protection layer may include at least one of a thermoplastic and a B-stage thermoset. In some embodiments, the polymer of the discontinuous transport protection layer may consist essentially of a B-stage thermoset, e.g. a B-stage thermoset after final cure. In some embodiments, polymer of the discontinuous transport protection layer includes, but is not limited to, at least one of epoxy resin, phenolic resin, ionic polymer, polyurethane, urea-formadehyde resin, melamine resin, polyesters, e.g. polyethylene terephthalate, polyethylene naphthalate, polyamide, polyether, polycarbonate, polyimide, polysulphone, polyphenylene oxide, polyacrylates, polymethacylates, polyolefin, e.g. polyethylene and polypropylene, styrene and styrene based random and block copolymers, e.g. styrene-butadiene-styrene, polyvinyl chloride, and fluorinated polymer, e.g. polyvinylidene fluoride and polytetrafluoroethylene. In some embodiments, the polymer of the discontinuous transport protection layer may be at least one of polyurethane, polyester, polyamide, polyether, polycarbonate, polyimide, polysulphone, polyphenylene oxide, polyacrylate, polymethacylate, polyolefin, styrene and styrene based random and block copolymers, polyvinyl chloride, and fluorinated polymer. The polymer of the discontinuous transport protection layer may be a polymer blend or polymer composite. In some embodiments, the polymer blend and/or composite may include at least two polymers selected from the polymers of the present disclosure.

In some embodiments, the discontinuous transport protection layer, comprising polymer, may include inorganic material, e.g. and inorganic woven structure and/or inorganic nonwoven structure which includes inorganic fiber, for example glass fiber. In these embodiments, the inorganic woven structure and inorganic nonwoven structure may include a polymer coating. In some embodiments, the discontinuous transport protection layer includes from about 5 percent to about 100 percent, from about 10 percent to about 100 percent, from about 20 percent to about 100 percent, from about 30 percent to about 100 percent, from about 40 to about 100 percent, from about 50 to about 100 percent, from about 60 to about 100 percent, from about 70 percent to 100 percent or even from about 80 to about 100 percent by weight polymer. In some embodiments, it may be desirable for the discontinuous transport protection layer to include from at least about 70 percent to 100 percent by weight polymer, due to at least one of lower cost, lower weight and ease of processing.

In some embodiments, the polymer of the discontinuous transport protection layer has a softening temperature from about 50 degrees centigrade to about 400 degrees centigrade, from about 50 degrees centigrade to about 350 degrees centigrade, from about 50 degrees centigrade to about 300 degrees centigrade or even from about 50 degrees centigrade to about 250 degrees centigrade. In some embodiments, the discontinuous transport protection layer is non-tacky at 25 degrees centigrade, 30 degrees centigrade, 40 degree centigrade, or even 50 degrees centigrade. In some embodiments, the polymer of the discontinuous transport protection layer contains from about 0 percent to about 15 percent by weight, from about 0 percent to about 10 percent by weight, from about 0 percent to about 5 percent by weight, from about 0 percent to about 3 percent by weight, from about 0 percent to about 1 percent by weight or even substantially 0 percent by weight pressure sensitive adhesive in the form of a polymer blend. Low modulus and/or highly viscoelastic materials, such as a pressure sensitive adhesive, may flow during use, due to the compression forces within an electrochemical cell or liquid flow battery, and may make it difficult to obtain the desired separation between cell or battery components. In some embodiments, the electrode assembly and/or membrane-electrode assembly is substantially free of a pressure sensitive adhesive and/or a pressure sensitive adhesive layer. In some embodiments the modulus, e.g. Young's modulus, of the polymer of the discontinuous transport protection layer may be from about 0.010 GPa to about 10 GPa, from about 0.1 GPa to about 10 GPa, from about 0.5 GPa to about 10 GPa, from about 0.010 GPa to about 5 GPa, from about 0.1 GPa to about 5 GPa or even from about 0.5 GPa to about 5 GPa.

The polymer of the discontinuous transport protection layer may be ionic polymer. Ionic polymer include, but is not limited to, ion exchange resin, ionomer resin and combinations thereof. Ion exchange resins may be particularly useful. The ionic polymer of discontinuous transport protection layer may include polymer wherein a fraction of the repeat units are electrically neutral and a fraction of the repeat units have an ionic functional group, i.e. an ionic repeat unit. In some embodiments, the ionic polymer has a mole fraction of repeat units having an ionic functional group of between about 0.005 and about 1.

Ionic polymer may include conventional thermoplastics and thermosets that have been modified by conventional techniques to include at least one of type of ionic functional group, e.g. anionic and/or cationic. Useful thermoplastic resins that may be modified include, but are not limited to, at least one of polyethylene, e.g. high molecular weight polyethylene, high density polyethylene, ultra-high molecular weight polyethylene, polypropylene, e.g. high molecular weight polypropylene, polystyrene, poly(meth)acrylates, e.g. polyacrylates based on acrylic acid that may have the acid functional group exchanged for, for example, an alkali metal, chlorinated polyvinyl chloride, fluoropolymer, e.g. perfluorinated fluoropolymer and partially fluorinated fluoropolymer (for example polytetrafluoroethylene (PTFE) and polyvinylidene fluoride (PVDF) each of which may be semi-crystalline and/or amorphous, polyetherimides and polyketones. Useful thermoset resins include, but are not limited to, at least one of epoxy resin, phenolic resin, polyurethanes, urea-formadehyde resin and melamine resin. Ionic polymer includes, but are not limited to, ion exchange resins, ionomer resins and combinations thereof. Ion exchange resins may be particularly useful.

As defined herein, ionic polymer include polymer wherein a fraction of the repeat units are electrically neutral and a fraction of the repeat units have an ionic functional group. In some embodiments, the ionic polymer has a mole fraction of repeat units with ionic functional groups between about 0.005 and 1. In some embodiments, the ionic polymer is a cationic resin, i.e. its ionic functional groups are negatively charged and facilitate the transfer of cations, e.g. protons, optionally, wherein the cationic resin is a proton cationic resin. In some embodiments, the ionic polymer is an anionic exchange resin, i.e. its ionic functional groups are positively charged and facilitate the transfer of anions. The ionic functional group of the ionic polymer may include, but is not limited, to carboxylate, sulphonate, sulfonamide, quaternary ammonium, thiuronium, guanidinium, imidazolium and pyridinium groups. Combinations of ionic functional groups may be used in an ionic polymer.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.03 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolomer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane, e.g. ion exchange membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The ionic polymer may be a mixture of ionomer resin and ion exchange resin.

The polymer of the discontinuous transport protection layer may include a hydrophilic polymer, e.g. ionic polymer previously disclosed herein having a mole fraction of repeat units having ionic functional groups of between about 0.03 and about 1, between about 0.05 and about 1, between about 0.10 and 1, between about 0.03 and about 0.8, between about 0.05 and 0.80 or even between about 0.1 and 0.80. In some embodiments, the discontinuous transport protection layer comprises from about 5 percent to about 100 percent by weight, from about 10 percent to 100 percent by weight, from about 25 percent to about 100 percent by weight, from about 5 percent to about 80 percent by weight, from about 10 percent to 80 percent by weight, from about 25 percent to about 80 percent by weight, from about 5 percent to about 60 percent by weight, from about 10 percent to 60 percent by weight or even from about 25 percent to about 60 percent by weight of a hydrophilic polymer. In some embodiments, the hydrophilic polymer may be included in the polymer as a polymer blend or may be included as a polymer coating. In some embodiments the discontinuous transport protection layer includes a hydrophilic polymer coating. Hydrophilic polymers know in the art may be used, including but not limited to, polyacrylic acids, polymethacylic acids, polyvinyl alcohols, polyvinyl acetate, polyethylene glycol, polypropylene glycol, polyethylene oxide, polypropylene oxide, polyacrylamides, maleic anhydride polymers, cellulosic polymers, polyelectrolytes and polymers with amine groups in their main chain or side chains, e.g. nylon 6, 6, nylon 7, 7, and nylon 12, polysulfone, epoxies, polyester, and polycarbonate.

In some embodiments, the discontinuous transport protection layer includes a hydrophilic coating. The hydrophilic coating may be an organic material or inorganic material. The hydrophilic coating may include at least one of a high molecular weight molecular species (number average molecular weight greater than 10000 g/mol,), an oligomeric molecular species (number average molecular weight greater than 1000 g/mol and no greater than 10000 g/mol), a low molecular weight molecular species (number average molecular weight no greater than 1000 g/mol and no less than 20 g/mol) and combinations thereof. The hydrophilic coatings may include molecular species comprising one or more polar functional groups, e.g. acid, hydroxyl, ester, ether and/or amine. In some embodiments, the hydrophilic polymer and/or hydrophilic coating of the discontinuous transport protection layer may have a surface contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. The contact angle may be measured by known techniques in the art, including receding contact angle measurement and advancing contact angle measurements. In some embodiments, the hydrophilic polymer and/or hydrophilic coating of the discontinuous transport protection layer may have a receding contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the hydrophilic polymer and/or hydrophilic coating of the discontinuous transport protection layer may have an advancing contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the discontinuous transport protection layer may have an advancing contact angle and/or receding contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. Use of hydrophilic polymers and/or coatings for the discontinuous transport protection layer may improve liquid transport, e.g. anolyte and/or catholyte flow, through the layer and improve electrochemical cell and/or liquid flow battery performance.

The polymer comprising the mesh structure, e.g. mesh structure 15a, woven structure, e.g. woven structure 15b, and/or nonwoven structure, e.g. nonwoven structure 15c, of the discontinuous transport protection layers of the present disclosure may be a solid, being substantially free of any voids or porosity. For example, the discontinuous transport protection layers of FIGS. 3A-3H may each be formed from a polymer and the polymer may be a solid, substantially free of any voids or porosity. In some embodiments, the polymer of the discontinuous transport protection layer has between about 0 and about 5 percent porosity by volume, between about 0 percent and about 3 percent porosity by volume or even between about 0 percent and about 1 percent porosity by volume. In some embodiments, it may be desired to maintain a low porosity within the polymer of the discontinuous transport protection layer, in order to provide a higher modulus material that can better resist compression forces that are present when used in an electrochemical cell or liquid flow battery and/or to maintain the desired spacing between components, e.g. the desired spacing between the porous electrode and ion permeable membrane.

In some embodiments, the discontinuous transport protection layer is non-conductive. The discontinuous transport protection layer may contain small amounts of electrically conductive material or other fillers, e.g. non-electrically conductive particulate. In some embodiments, the discontinuous transport protection layer contains between about 0 percent and about 5 percent by weight, between about 0 and about 3 percent by weight, between about 0 and about 1 percent or even substantially 0% by weight of at least one of an electrically conductive particulate and a non-electrically conductive particulate.

The thickness, T, of the discontinuous transport protection layer is not particularly limited. In some embodiments, the thickness of the discontinuous transport protection layer, e.g. the thickness of at least one of a plurality of discrete structures, a mesh structure, a woven structure and a nonwoven structure, is from about 0.05 micron to about 3000 microns, from about 0.05 micron to about 2000 microns, from about 0.05 micron to about 1000 microns, about 0.05 micron to about 500 microns, from about 1 micron to about 3000 microns, from about 1 micron to about 2000 microns, from about 1 micron to about 1000 microns, about 1 micron to about 500 microns, from about 10 microns to about 3000 microns, from about 10 microns to about 2000 microns, from about 10 microns to about 1000 microns, about 10 microns to about 500 microns, from about 50 microns to about 3000 microns, from about 50 microns to about 2000 microns, from about 50 microns to about 1000 microns, or even from about 50 microns to about 500 microns.

In some embodiments, to maximize the resistance to shorting of a cell or battery (associated with, for example, carbon fiber penetration of the ion permeable membrane), it may be desirable to have a thicker discontinuous transport protection layer. In these embodiments, the thickness of the discontinuous transport protection layer may be on the higher end of the ranges of thickness described above. For example, the thickness of the discontinuous transport protection layer may be from about 25 microns to about 3000 microns, from about 25 microns to about 2000 microns, from about 25 microns to about 1000 microns, from about 25 microns to about 500 microns, from about 50 microns to about 3000 microns, from about 50 microns to about 2000 microns, from about 50 microns to about 1000 microns, from about 50 microns to about 500 microns, from about 75 microns to about 3000 microns, from about 75 microns to about 2000 microns, from about 75 microns to about 1000 microns, from about 75 microns to about 500 microns, from about 100 microns to about 3000 microns, from about 100 microns to about 2000 microns, from about 100 microns to about 1000 microns, or even from about 100 microns to about 500 microns.

In some embodiments, to enhance cell resistance and/or short resistance, the thickness of the porous protection layer may be between about 25 microns and about 500 microns, between about 50 microns and about 500 microns, between about 75 microns and about 500 microns, between about 100 microns and about 500 microns, between about 25 microns and about 400 microns, between about 50 microns and about 400 microns, between about 75 microns and about 400 microns, between about 100 microns and about 400 microns, between about 25 microns and about 300 microns, between about 50 microns and about 300 microns, between about 75 microns and about 300 microns, or even between about 100 microns and about 300 microns.

In some embodiments, in order to improve the cell resistance (lower the cell resistance), it may be desirable to have a thinner discontinuous transport protection layer. In these embodiments, the thickness of the discontinuous transport protection layer may be on the lower end of the ranges of thickness described above. For example, the thickness of the discontinuous transport protection layer may be between about 25 microns and about 500 microns, between about 50 microns and about 500 microns, between about 75 microns and about 500 microns, between about 100 microns and about 500 microns, between about 25 microns and about 400 microns, between about 50 microns and about 400 microns, between about 75 microns and about 400 microns, between about 100 microns and about 400 microns, between about 25 microns and about 300 microns, between about 50 microns and about 300 microns, between about 75 microns and about 300 microns, or even between about 100 microns and about 300 microns.

In some embodiments, the discontinuous transport protection layer may include a mesh structure (see FIGS. 3A and 3D). Mesh structure include a continuous sheet or layer having a plurality of open regions, e.g. a plurality of through-holes. A mesh structure may include, for example, a polymer film with a plurality of through-holes. The mesh structure of the present disclosure does not include conventional woven and nonwoven structures, i.e. woven and nonwoven substrates. The shape of the plurality of open regions of the mesh structure is not particularly limited and includes, but is not limited to, circular, elliptical, irregular polygons and regular polygons, e.g. triangle, quadrilateral (square, rectangle, rhombus and trapezoid), pentagon, hexagon and octagon. Combinations of shapes may be used. In some embodiments, the plurality of open regions of the mesh structure may have a length and/or width of from about 10 microns to about 10 mm, 50 microns to about 10 mm, 100 microns to about 10 mm, from about 200 microns to about 10 mm, from about 500 microns to about 10 mm, from about 1000 microns to about 10 mm, 10 microns to about 8 mm, 50 microns to about 8 mm, from about 100 microns to about 8 mm, from about 200 microns to about 8 mm, from about 500 microns to about 8 mm, from about 1000 microns to about 8 mm, 10 microns to about 6 mm, 50 microns to about 6 mm, from about 100 microns to about 6 mm, from about 200 microns to about 6 mm, from about 500 microns to about 6 mm, from about 1000 microns to about 6 mm or even from about 10 microns to about 1000 microns. The depth of the plurality of open regions may correspond to the thickness, T, of the discontinuous transport protection layer, as previously described. The dimensions, i.e. length, width and/or depth of each open region may be substantially the same or may be different. The plurality of open regions of the mesh structure may be random or may be in a pattern. Patterns include, but are not limited to, square arrays, hexagonal arrays and the like. Combination of patterns may be used.

Mesh structures may be fabricated by known techniques in the art. For example, a polymer film may be fabricated by an extrusion process and a plurality of open regions may be formed in the polymer film via techniques known in the art, including, but not limited to, die cutting, laser cutting, water jet cutting, needle punching, etching and the like. A mesh structure may also be formed by an extrusion process where a first set of strands of polymer, substantially parallel to one another, for example, are extruded in one direction on a porous electrode and a second set of polymer strands, substantially parallel to one another, yet off-set by an angle, theta, relative to the first set of strands, is extruded on the porous electrode, thereby forming a mesh structure. Theta may be from about 5 degrees to about 90 degrees, from about 15 degrees to about 90 degrees, from about 30 degrees to about 90 degrees or even from about 45 degrees to about 90 degrees.

In some embodiments, the discontinuous transport protection layer may include a woven structure, i.e. a woven substrate (see FIGS. 3E and 3F) having a plurality of open regions. Conventional woven structures known in the art may be used, e.g. woven cloths and woven fabrics. In some embodiments, the plurality of open regions of the woven structure may have a length and/or width of from about 10 microns to about 10 mm, from about 50 microns to about 10 mm, from about 100 microns to about 10 mm, from about 200 microns to about 10 mm, from about 500 microns to about 10 mm, from about 1000 microns to about 10 mm, from about 10 microns to about 8 mm, from about 50 microns to about 8 mm, from about 100 microns to about 8 mm, from about 200 microns to about 8 mm, from about 500 microns to about 8 mm, from about 1000 microns to about 8 mm, from about 10 microns to about 6 mm, from about 50 microns to about 6 mm, from about 100 microns to about 6 mm, from about 200 microns to about 6 mm, from about 500 microns to about 6 mm, or even from about 1000 microns to about 6 mm. The depth of the plurality of open regions may correspond to the thickness, T, of the discontinuous transport protection layer, as previously described.

In some embodiments, the discontinuous transport protection layer may include a nonwoven structure, i.e. a nonwoven substrate (see FIGS. 3G and 3H) having open regions, the open regions may be substantially interconnected. Conventional nonwoven structures known in the art may be used, e.g. nonwoven paper, nonwoven felt and nonwoven web.

The woven and nonwoven structures of the discontinuous transport protection layer of the present disclosure may be non-conductive structures. The woven and nonwoven structures of the discontinuous transport protection layer, generally, include fiber. In some embodiments, the discontinuous transport protection layers includes a woven non-conductive structure and is free of a nonwoven non-conductive structure. In some embodiments, the discontinuous transport protection layers includes a nonwoven non-conductive structure and is free of a woven non-conductive structure. The woven and nonwoven non-conductive structure of the discontinuous transport protection layer include polymer and, optionally may include an inorganic. The woven and nonwoven structures may include a non-conductive polymer material and, optionally, a non-conductive inorganic material. The woven and nonwoven non-conductive substrate may comprise fiber, e.g. a plurality of fibers. The woven and nonwoven structures may be fabricated from polymer fiber, e.g. non-conductive polymer fiber and, optionally inorganic fiber, e.g. non-conductive inorganic fiber. In some embodiments, the woven and nonwoven structures may include polymer fiber and exclude inorganic fiber.

In some embodiments, the fibers of the woven and nonwoven structures may have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 500 microns, from between about 0.001 to about 250 microns, from between about 0.001 to about 100 microns, from between about 0.001 microns to about 50 microns, from between about 0.001 to about 25 microns, from between about 0.001 microns to about 10 microns, from about 0.001 microns to about 1 microns, from between about from between about 0.01 to about 500 microns, from between about 0.01 to about 250 microns, 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 500 microns, from between about 0.05 to about 250 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 to about 500 microns, from between about 0.1 to about 250 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same. In some embodiments, smaller microfibers may be woven or bonded together to form macro-fibers having significantly larger dimension, e.g. width and/or thickness, than the individual fibers they are composed of.

The fibers may be fabricated into a woven and nonwoven structure using conventional techniques. A nonwoven structure may be fabricated by a melt blown fiber process, spunbond process, a carding process and the like. In some embodiments, the length to thickness and length to width aspect ratios of the fiber may be greater than 1000000, greater than about 10000000 greater than about 100000000 or even greater than about 1000000000. In some embodiments, the length to thickness and length to width aspect ratios of the fiber may be between about 10 to about 1000000000; between about 10 and about 100000000 between about 10 and about 10000000, between about 20 to about 1000000000; between about 20 and about 100000000 between about 20 and about 10000000, between about 50 to about 1000000000; between about 50 and about 100000000 or even between about 50 and about 10000000.

The at least one of a woven and nonwoven structure may include conventional woven and nonwoven paper, felt, mats and cloth (fabrics) known in the art. The woven and nonwoven structure may include polymer fiber and, optionally, ceramic fiber. The number of types, polymer fiber types and ceramic fiber types, used to form the at least one of a woven and nonwoven non-conductive substrate, is not particularly limited. The polymer fiber may include at least one polymer, e.g. polymer composition or one polymer type. The polymer fiber may include at least two polymers, i.e. two polymer compositions or two polymer types. The polymer fiber may be a core-sheath polymer fiber composed of at least two different polymer types. For example, the polymer fiber may include one set of fibers composed of polyethylene and another set of fibers composed of polypropylene. If at least two polymers are used, the first polymer fiber may have a lower glass transition temperature and or melting temperature than the second polymer fiber. The first polymer fiber may be used for fusing the polymer fiber of the at least one of a woven and nonwoven structure together, to improve, for example, the mechanical properties of the woven and nonwoven structure. The optional ceramic fiber may include at least one ceramic, e.g. one ceramic composition or one ceramic type. The optional ceramic fiber may include at least two ceramics, i.e. two ceramic compositions or two ceramic types. The woven and nonwoven structures may include at least one polymer fiber, e.g. one polymer composition or polymer type, and at least one ceramic fiber, e.g. one ceramic composition or one ceramic type. For example, the at least one of a woven and nonwoven non-structure may include polyethylene fiber and glass fiber.

The basis weight of the at least one of a woven and nonwoven structure is not particularly limited. In some embodiments, the basis weight of the at least one of a woven and nonwoven structure, measured in gram per square meter (gsm) of material, may be between about 4 gsm and about 60 gsm, between about 4 gsm and about 50 gsm, between about 4 gsm and about 40 gsm, between about 4 gsm and about 32 gsm, between about 6 gsm and about 60 gsm, between about 6 gsm and about 50 gsm, between about 6 gsm and about 40 gsm, between about 6 gsm and about 32 gsm, between about 8 gsm and about 60 gsm, between about 8 gsm and about 50 gsm, between about 8 gsm and about 40 gsm or even between about 8 gsm and about 32 gsm.

In some embodiments, the woven and nonwoven structure may include small amounts of one or more conductive material, so long as the conductive material does not alter the at least one of a woven and nonwoven non-conductive substrate to be conductive. In some embodiments, the at least one of a woven and nonwoven non-conductive structure is substantially free of conductive material. In this case, “substantially free of conductive material” means that the at least one of a woven and nonwoven non-conductive substrate includes less than about 25% by wt., less than about 20% by wt., less than about 15% by wt., less than about 10% by wt., less than about 5% by wt., less than about 3% by wt., less than about 2%, by wt., less than about 1% by wt., less than about 0.5% by wt., less than about 0.25% by wt., less than about 0.1% by wt., or even 0.0% by wt. conductive material.

The polymer fiber of the at least one of a woven and nonwoven structure is not particularly limited. In some embodiments, the polymer fiber of the at least one of a woven and nonwoven structure is non-conductive. In some embodiments, the polymer fiber of the woven and nonwoven structure may include least one of a thermoplastic and thermoset. Thermoplastics may include thermoplastic elastomers. A thermoset may include a B-stage polymer. In some embodiments, polymer fiber of the woven and nonwoven structure includes, but is not limited to, at least one of epoxy resin, phenolic resin, polyurethane, urea-formadehyde resin, melamine resin, polyester, e.g. polyethylene terephthalate, polyethylene naphthalate, polyamide, polyether, polycarbonate, polyimide, polysulphone, polyphenylene oxide, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the polymer fiber comprises at least one of polyurethane, polyester, polyamide, polyether, polycarbonate, polyimides, polysulphone, polyphenylene oxide, polyacrylates, polymethacylates, polyolefin, styrene and styrene based random and block copolymers, polyvinyl chloride, and fluorinated polymer.

The optional ceramic fiber of the woven and nonwoven structure is not particularly limited. The ceramic of the ceramic fiber may include, but is not limited to, metal oxides, for example silicon oxide, e.g. glass and doped glass, and aluminum oxide.

If a ceramic fiber is used as the woven and/or nonwoven structure, the ceramic fiber may include, but is not limited to at least one of metal oxides, for example silicon oxide, e.g. glass and doped glass, and aluminum oxide.

The discontinuous transport protection layer may be a multi-layer structure. In some embodiments, the discontinuous transport protection layer comprises at least one layer. In some embodiments, the discontinuous transport protection layer comprises two or more layers. The layers of the discontinuous transport protection layer may be the same composition and/or structure or may include two or more different compositions and/or two or more different structures.

The discontinuous transport protection layers of the present disclosure may further include an ionic resin coating over at least a portion of discontinuous transport protection layer. The ionic resin coating of the discontinuous transport protection layer should allow the select ion(s) of the electrolytes to transfer through the discontinuous transport protection layer. This may be achieved by allowing the electrolyte to easily wet and absorb into a given discontinuous transport protection layer. The material properties, particularly the surface wetting characteristics of the discontinuous transport protection layer may be selected based on the type of anolyte and catholyte solution, i.e. whether they are aqueous based or non-aqueous based. In some embodiments the ionic resin of the ionic resin coating may have a surface contact angle with water, catholyte and/or anolyte of between about 90 degrees and 0 degrees, of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the ionic resin coats at least 10%, at least 20%, at least 30%, at least 40%, at least 50%, at least 60%, at least 70%, at least 75%, at least 80%, at least 85%, at least 90%, at least 95% or even at least 100% of the surface area of the discontinuous transport protection layer. As improvement in the wettability, generally, increase with the area of coverage of the ionic resin coating, higher areal coverage may be preferred.

The ionic resin coating may be formed from a precursor ionic resin containing one or more of monomer and oligomer which may be cured to form an ionic resin coating. The precursor ionic resin may also contain dissolved polymer. The precursor ionic resin may contain solvent which is removed prior to or after curing of the precursor ionic resin. The ionic resin may be formed from a dispersion of ionic resin particles, the solvent of the dispersion being removed to form the ionic resin coating of the discontinuous transport protection layer. The ionic resin coating may include an ionic polymer, which may be dispersed or dissolved in a solvent, the solvent being removed to form the ionic resin coating of the discontinuous transport protection layer. The ionic resin coating may include at least one of ionic polymer, ionomer resin and ion exchange resin, as previously described herein.

The ratio of the weight of the ionic resin to total weight of the discontinuous transport protection layer is not particularly limited. In some embodiments, the ratio of the weight of the ionic resin to the total weight of the discontinuous transport protection layer is from about 0.03 to about 0.95, from about 0.03 to about 0.90, from about 0.03 to about 0.85, from about 0.03 to about 0.80, from about 0.03 to about 0.70, from about 0.05 to about 0.95, from about 0.05 to about 0.90, from about 0.05 to about 0.85, from about 0.05 to about 0.80, from about 0.05 to about 0.70, from about 0.10 to about 0.95, from about 0.10 to about 0.90, from about 0.10 to about 0.85, from about 0.10 to about 0.80, from about 0.10 to about 0.70, from about 0.20 to about 0.95, from about 0.20 to about 0.90, from about 0.20 to about 0.85, from about 0.20 to about 0.80, from about 0.20 to about 0.70, from about 0.30 to about 0.95, from about 0.30 to about 0.90, from about 0.30 to about 0.85, from about 0.30 to about 0.80, from about 0.30 to about 0.70, from about 0.40 to about 0.95, from about 0.40 to about 0.90, from about 0.40 to about 0.85, from about 0.40 to about 0.80, or even from about 0.40 to about 0.70.

Coating techniques know in the art may be used including, but not limited to, brush coating, dip coating, spray coating, knife coating, e.g. slot-fed knife coating, notch bar coating, metering rod coating, e.g. Meyer bar coating, die coating, e.g. fluid bearing die coating, roll coating, e.g. three roll coating, curtain coating and the like.

In some embodiments, the ionic resin is coated on at least a portion of the fiber surface of discontinuous transport protection layer in the form an ionic resin coating solution, e.g. a solution that includes the ionic resin, solvent and any other desired additives. The volatile components of the ionic resin coating solution, e.g. solvent, are removed by drying, leaving the ionic resin on at least a portion of the surface of discontinuous transport protection layer. Ionic resin coating solutions may be prepared by solution blending, which includes combining the resin, an appropriate solvent and any other desired additives, followed by mixing at the desired shear rate. Mixing may include using any techniques known in the art, including blade mixers and conventional milling, e.g. ball milling. Other additives to the ionic resin coating solutions may include, but are not limited to, surfactants, dispersants, thickeners, wetting agents and the like. Surfactants, dispersants and thickeners may help to facilitate the ability of the ionic resin coating solution to wet the surface of the discontinuous transport protection layer. They may also serve as viscosity modifiers. Prior to making the coating solution, the ionic resin may be in the form of a dispersion or a suspension, as would be generated if the ionic resin was prepared via an emulsion polymerization technique or suspension polymerization technique, for example. Additives, such as surfactants, may be used to stabilize the ionic resin dispersion or suspension in their solvent.

Solvent useful in the ionic resin coating solution may be selected based on the ionic resin type. Solvents useful in the ionic resin coating solution include, but are not limited to, water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The amount of solvent, on a weight basis, in the ionic resin coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

Surfactants may be used in the ionic resin coating solutions, for example, to improve wetting. Surfactants may include cationic, anionic and nonionic surfactants. Surfactants useful in the ionic resin coating solution include, but are not limited to TRITON X-100, available from Dow Chemical Company, Midland, Mich.; DISPERSBYK 190, available from BYK Chemie GMBH, Wesel, Germany; amines, e.g. olyelamine and dodecylamine; amines with more than 8 carbons in the backbone,e.g. 3-(N, N-dimethyldodecylammonio) propanesulfonate (SB12); SMA 1000, available from Cray Valley USA, LLC, Exton, Pa.; 1,2-propanediol, triethanolamine, dimethylaminoethanol; quaternary amine and surfactants disclosed in U.S. Pat. Publ. No. 2013/0011764, which is incorporated herein by reference in its entirety. If one or more surfactants are used in the ionic resin coating solution, the surfactant may be removed from the discontinuous transport protection layer by a thermal process, wherein the surfactant either volatilizes at the temperature of the thermal treatment or decomposes and the resulting compounds volatilize at the temperature of the thermal treatment. In some embodiments, the ionic resin is substantially free of surfactant. By “substantially free” it is meant that the ionic resin contains, by weight, from 0 percent to 0.5 percent, from 0 percent to 0.1 percent, from 0 percent to 0.05 percent or even from 0 percent to 0.01 percent surfactant. In some embodiments, the ionic resin contains no surfactant. The surfactant may be removed from the ionic resin by washing or rinsing with a solvent of the surfactant. Solvents include, but are not limited to water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The discontinuous transport protection layer may be formed with ionic resin coating solution by coating the solution on a liner or release liner. A first major surface of a discontinuous transport protection layer, for example a first major surface of a woven or nonwoven structure, may then be placed in contact with the ionic resin coating solution. The discontinuous transport protection layer is removed from the liner and at least a portion of the first major surface of the discontinuous transport protection layer is coated with the ionic resin coating solution. Optionally, a new liner or the same liner may be coated with the same or a different ionic resin coating solution and the second major surface of the discontinuous transport protection layer, may then be placed in contact with the ionic resin coating solution. The discontinuous transport protection layer is removed from the liner and at least a portion of the second major surface of the discontinuous transport protection layer is coated with the ionic resin coating solution. The discontinuous transport protection layer is then exposed to a thermal treatment, e.g. heat from an oven or air flow through oven, in order to remove the volatile compounds, e.g. solvent, from the ionic resin coating solution, producing a discontinuous transport protection layer comprising polymer and an ionic resin, which coats at least a portion of the surface of the polymer of the discontinuous transport protection layer. An alternative approach to fabricating the discontinuous transport protection layer would include coating the ionic resin coating solution directly onto the first and/or second major surfaces of the discontinuous transport protection layer, for example, followed by a thermal treatment, e.g. heat from an oven or air flow through oven, in order to remove the volatile compounds, e.g. solvent, from the ionic resin coating solution, producing a discontinuous transport protection layer having comprising polymer and an ionic resin, which coats at least a portion of the polymer surface the discontinuous transport protection layer. If the amount of coating solution is too great after coating, the discontinuous transport protection layer may be run through the nip of a two roll coater, for example, to remove some of the ionic resin coating solution, prior to thermal treatment.

If the ionic resin is in the from a precursor ionic resin, a discontinuous transport protection layer may be formed by coating at least one major surface of discontinuous transport protection layer comprising polymer with the precursor resin, wherein at least a portion of the polymer surface of the discontinuous transport protection layer is coated by the precursor ionic resin. The precursor ionic resin coating of the discontinuous transport protection layer may then be cured by any technique known in the art including, but not limited to, thermal curing, actinic radiation curing and e-beam curing. The precursor ionic resin may contain one or more of curing agents, catalyst, chain transfer agents, chain extenders and the like, as dictated by the cure chemistry of the precursor ionic resin and the desired final properties of the ionic resin. Curing the ionic resin precursor produces a discontinuous transport protection layer comprising polymer and an ionic resin, which coats at least a portion of the polymer surface of the discontinuous transport protection layer.

In some embodiments, at least one of the volume porosity and open area porosity of the discontinuous transport protection layer may be between about 0.10 and about 0.995, between about 0.10 and about 0.95, between about 0.10 and about 0.90, between about 0.10 and about 0.85, between about 0.10 and about 0.75, between about 0.15 and about 0.995, between about 0.15 and about 0.95, between about 0.15 and about 0.90, between about 0.15 and about 0.85, between about 0.15 and about 0.75, between about 0.25 and about 0.995, between about 0.25 and about 0.95, between about 0.25 and about 0.90, between about 0.25 and about 0.85, between about 0.25 and about 0.75, between about 0.35 and about 0.995, between about 0.35 and about 0.95, between about 0.35 and about 0.90, between about 0.35 and about 0.85, between about 0.35 and about 0.75, between about 0.45 and about 0.995, between about 0.45 and about 0.95, between about 0.45 and about 0.90, between about 0.45 and about 0.85, about 0.45 and about 0.75, between about 0.50 and about 0.995, between about 0.50 and about 0.95, between about 0.50 and about 0.90, between about 0.50 and about 0.85, between about 0.50 and about 0.75, between about 0.65 and about 0.995, between about 0.65 and about 0.95, between about 0.65 and about 0.90, between about 0.65 and about 0.85, or even between about 0.65 and about 0.75.

The volume porosity of the discontinuous transport protection layer is defined as the volume of the void space of the discontinuous transport layer divided by the total volume, i.e. bulk volume, of the discontinuous transport protection layer. Volume porosity may be determined by conventional techniques known in the art, e.g. direct methods, optical methods and gas expansion methods. For example, the volume porosity may be calculated from the following equation:

Volume Porosity=1−(Ds/Dm)

where,

Ds=density of a substrate (bulk density) in g/cm³ for example.

Dm=Density of the material making up the substrate in g/cm³ for example.

If the substrate happens to be a woven or nonwoven substrate containing more than one fiber type, then Dm is the weighted average density:

Weighted Average Density=D1(w1/w3)+D2(w2/w3)

where,

D1 is the density of component 1

D2 is the density of component 2

w1 is the weight of component 1

w2 is the weight of component 2

w3 is the total weight (w3=w1+w2)

For example, for a nonwoven substrate having a density, Ds, of 0.3 g/cm³ made from polyethylene fiber having a density of 0.95 g/cm³, the porosity would be (1-0.3/0.95) which is 0.684. The volume porosity is the volume fraction of pores or open volume in the substrate.

The open area porosity is the ratio of the area of the voids, e.g. through-holes, to the total area of the surface of the discontinuous transport protection layer at a major surface of the discontinuous transport protection layer (area of the through-holes and corresponding polymer). The open area porosity may be determined by conventional techniques known in the art. The open area porosity may be calculated, for example, for a mesh having a rectangular through hole of length, l, and width, w, and a fiber width or diameter for the weft fibers, Dwe, and warp fibers, Dwa, as follows (assuming the length of the hole corresponds to the direction of the warp fiber and the width of the hole corresponds to the direction of the weft fiber):

Open Area Porosity=(1×w)/[(1+Dwe)(w+Dwa)]

In some embodiments, to maximize the resistance to shorting of a cell or battery (associated with carbon fiber penetration of the ion permeable membrane), it may be desirable to have a less porous discontinuous transport protection layer. In these embodiments, at least one of the volume porosity and open area porosity of the discontinuous transport protection layer may be on the lower end of the ranges of volume porosity and/or open area porosity described above. For example, at least one of the volume porosity and open area porosity of the discontinuous transport protection layer may be between about 0.10 and about 0.65, between about 0.10 and about 0.55, between about 0.10 and about 0.45, between about 0.10 and about 0.35, between about 0.15 and about 0.65, between about 0.15 and about 0.55, between about 0.15 and about 0.45, or even between about 0.15 and about 0.35.

In some embodiments, to increase the fluid flow, i.e. the flow of anolyte and/or catholyte, in a cell or battery in order to maximize the cell resistance (lower the cell resistance), it may be desirable to have a more porous discontinuous transport protection layer. In these embodiments, at least one of the volume porosity and open area porosity of the discontinuous transport protection layer may be on the higher end of the ranges of volume porosity and/or open area porosity described above. For example, at least one of the volume porosity and open area porosity of the discontinuous transport protection layer may be between about 0.35 and about 0.995, between about 0.35 and about 0.95, between about 0.35 and about 0.90, between about 0.35 and about 0.85, between about 0.35 and about 0.75, between about 0.45 and about 0.995, between about 0.45 and about 0.95, between about 0.45 and about 0.90, between about 0.45 and about 0.85, or even between about 0.45 and about 0.75.

With respect to improving the short resistance and cell resistance of an electrochemical cell or battery containing a discontinuous transport protection layer of the present disclosure, a change in the porosity, either increasing or decreasing, generally, will improve one of the parameters while adversely affecting the other parameter. However, it has been surprisingly found that the resistance to shorting (associated with carbon fiber penetration of the ion permeable membrane) of an electrochemical cell may be improved while at least not significantly changing and, in some cases, improving the cell resistance of an electrochemical cell containing a discontinuous transport protection layer of the present disclosure. In these embodiments, at least one of the volume porosity and open area porosity of the discontinuous transport protection layer may be between about 0.35 and about 0.995, between about 0.35 and about 0.95, between about 0.35 and about 0.90, between about 0.35 and about 0.85, or even between about 0.35 and about 0.75.

The discontinuous transport protection layers of the present disclosure may be fabricated by a variety of techniques. In one embodiment, a continuous film of a thermoplastic or B-stage thermoset may be formed into a discontinuous transport protection layer, by for example, die cutting the desired open regions into the continuous film, forming a mesh structure. In another embodiment, a woven structure or nonwoven structure of thermoplastic fibers or B-stage thermoset fibers may be formed into a discontinuous transport protection layer, by for example, fabricating a woven structure or nonwoven structure using conventional techniques.

In some embodiments, the major surface of the discontinuous transport protection layer adjacent the ion permeable membrane may be laminated to a first major surface of the ion permeable membrane (e.g. an ion exchange membrane), using conventional lamination techniques, which may include at least one of pressure and heat, thereby forming a membrane-electrode assembly. It is assumed that the other major surface of the discontinuous transport protection layer is adhered to a porous electrode via an adhesive layer, e.g. a first adhesive layer. In some embodiments, a second discontinuous transport protection layer may be laminated to the opposed second major surface of the ion permeable membrane (e.g. an ion exchange membrane), using conventional lamination techniques, which may include at least one of pressure and heat, thereby forming a membrane-electrode assembly. It is assumed that the other major surface of the second discontinuous transport protection layer is adhered to a second porous electrode via an adhesive layer, e.g. a second adhesive layer.

The adhesive layers (e.g. first adhesive layer, second adhesive layer, third adhesive layer, fourth adhesive layer, first gasket adhesive layer and second gasket adhesive layer) of the present disclosure may include at least one of a pressure sensitive adhesive, a hot melt adhesive and a thermosetting adhesive. Pressure sensitive adhesives that may be used in the adhesive layers of the present disclosure include, but are not limited to, those based on acrylates, silicones, nitrile rubber, butyl rubber, natural rubber, styrene block copolymers, urethane and the like. Pressure sensitive adhesives based on poly(meth)acrylates may be particularly suitable.

Heat activated adhesives are adhesives that may act as an adhesive, e.g. a pressure sensitive adhesive or structural adhesive, at ambient or use temperature, while having the ability to flow, similar to a liquid, at an elevated temperature. Heat activated adhesives include hot melt adhesives, are adhesives that are semi-crystalline or amorphous and have the ability to flow when they are heated to a temperature above their crystalline melting temperature, Tm, and/or above their glass transition temperature, Tg. Once cooled back to a temperature below their Tm and/or Tg, the hot melt adhesive solidifies and provides adhesive properties. The hot melt adhesive may include at least one of a polyurethane, polyamide, polyester, polyacrylate, polyolefin, polycarbonate and epoxy resin. The hot melt adhesive may be capable of being cured. Curing the hot melt adhesive may comprise at least one of moisture curing, thermal curing and actinic radiation curing. Heat activated adhesives may include the adhesives disclosed in U.S. Pat. Publ. No. 2012/0325402 (Suwa, et. al.) and U.S. Pat. No. 7,008,680 (Everaerts, et. al.) and U.S. Pat. No. 5,905,099 (Everaerts, et. al.), all incorporated herein by reference.

The adhesives of the present disclosure may be applied to the membrane-electrode assembly by known techniques in the art including lamination, e.g. lamination of an adhesive layer to the discontinuous transport protection layer of an electrode assembly via use of an adhesive transfer tape; and various coating and printing techniques, e.g. screen printing an adhesive on the discontinuous transport protection layer of an electrode assembly.

The adhesive layers (e.g. first adhesive layer, second adhesive layer, third adhesive layer, fourth adhesive layer, first gasket adhesive layer and second gasket adhesive layer) may be in the shape of an annulus, i.e. an annular shaped adhesive layer. The term “annulus” and/or “annular” is generally used to describe a ring shaped object bounded by two concentric circles. However, in the present disclosure, the term “annulus” and/or “annular” will refer to a ring shaped objected. The shape of the annulus is not particularly limited and may include, but is not limited to, a circle, square, rectangle, triangle, oval and diamond. The adhesive layers may be disposed along the perimeter of the membrane-electrode assembly. In some embodiments, one or more of the adhesive layers, e.g. first adhesive layer, second adhesive layer, third adhesive layer and fourth adhesive layer, may be disposed along the perimeter of the membrane-electrode assembly and be a series of discontinuous lines or strips. In some embodiments, one or more of the adhesive layers e.g. first adhesive layer, second adhesive layer, third adhesive layer and fourth adhesive layer, may be disposed along the perimeter of the membrane-electrode assembly and include two adhesive regions, e.g. two discrete adhesive lines (e.g. strips), on opposite sides (e.g. across from one another) of the membrane-electrode assembly perimeter.

The first and second gaskets may be prepared from materials typically used as gasket material in the field of liquid flow batteries. Although the material used for the gasket is not particularly limited, generally, the material of the gasket has good chemical resistance to the anolyte and/or catholyte used in the liquid flow batteries. The first and/or second gasket may include at least one polymer. In some embodiments the first and/or second gasket may include, but is not limited to, at least one of polyester, e.g. polyethylene terephthalate, polyamide, polycarbonate, polyimide, polysulphone, polyphenylene oxide, polyethylene naphthalate, polyacrylates, polymethacylates, polyolefin, e.g. polyethylene and polypropylene, styrene and styrene based random and block copolymers, e.g. styrene-butadiene-styrene, polyvinyl chloride, and fluorinated polymer, e.g. polyvinylidene fluoride and polytetrafluoroethylene. The first and/or second gasket may be in the shape of an annulus, i.e. an annular shaped first gasket and/or an annular shaped second gasket. The term “annulus” and/or “annular” is generally used to describe a ring shaped object bounded by two concentric circles. However, in the present disclosure, the term “annulus” and/or “annular” will refer to a ring shaped objected. The shape of the annulus is not particularly limited and may include, but is not limited to, a circle, square, rectangle, triangle, oval and diamond. The first gasket and/or second gasket may be disposed along the perimeter of the membrane-electrode assembly. The first gasket and/or second gasket may be disposed between the ion permeable membrane and an adjacent adhesive layer. The first gasket and/or second gasket may be in contact with one or both the ion permeable membrane and an adjacent adhesive layer.

Throughout this disclosure, the first and second gaskets have been diagramed (see FIGS. 1I through 1M and 2E, for example) to have the same width as that of the membrane-electrode assembly, but that is not a requirement. In some embodiments, the width of the first and/or second gaskets may be less than the width of at least one of the membrane electrode assembly and the discontinuous transport protection layer. In some embodiments, the width of the first and/or second gaskets may be greater than the width of at least one of the membrane electrode assembly and the discontinuous transport protection layer. When the width of the first and or second gasket is greater than the width of at least one of the membrane electrode assembly and the discontinuous transport protection layer, the gasket may be used to seal the membrane electrode assembly, when included in an electrochemical cell or liquid flow battery.

The membrane-electrode assemblies of the present disclosure include an ion permeable membrane, ion exchange membranes being particularly useful. Ion permeable membranes and ion exchange membranes known in the art may be used. Ion permeable membranes, e.g. ion exchange membranes, are often referred to as separators and may be prepared from ionic polymers, for example, those previously discussed for the ionic polymer of the discontinuous transport protection layer including, but not limited to, ion exchange resin, ionomer resin and combinations thereof. In some embodiments, the membranes, e.g., ion exchange membranes may include a fluorinated ion exchange resin. Membranes, e.g. ion exchange membranes, useful in the embodiments of the present disclosure may be fabricated from ion exchange resins and/or ionomer known in in the art or may be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company and materials described in U.S. Pat. No. 7,348,088, incorporated herein by reference in its entirety. In some embodiments, the ion exchange membrane includes a fluoropolymer. In some embodiments, the fluoropolymer of the ion exchange membrane may contain between about 10% to about 90%, from about 20% to about 90%, from about 30% to about 90% or even from about 40% to about 90% fluorine by weight.

The membranes, e.g. ion permeable membranes, of the present disclosure may be obtained as free standing films from commercial suppliers or may be fabricated by coating a solution of the appropriate membrane resin, e.g. ion exchange membrane resin, in an appropriate solvent, and then heating to remove the solvent. The membrane may be formed from a coating solution by coating the solution on a release liner and then drying the membrane coating solution coating to remove the solvent.

Any suitable method of coating may be used to coat the membrane coating solution on a release liner. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Coating may be achieved in one pass or in multiple passes. Coating in multiple passes may be useful to increase coating weight without corresponding increases in cracking of the ion permeable membrane.

The amount of solvent, on a weight basis, in the membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of membrane resin, e.g. ion exchange resin and ionomer resin, on a weight basis, in the membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The thickness of the ion permeable membrane may be from about 5 microns to about 250 microns, from about 5 microns to about 200 microns, from about 5 microns to about 150 microns, from about 5 microns to about 100 microns, from about 10 microns to about 250 microns, from about 10 microns to about 200 microns, from about 10 microns to about 150 microns, from about 5 microns to about 10 microns, from about 15 microns to about 250 microns, from about 15 microns to about 200 microns, from about 15 microns to about 150 microns, or even from about 15 microns to about 100 microns.

Throughout this disclosure the ion permeable membrane has been diagramed (see FIGS. 1A through 2E, for example) to have the same width as that of the membrane-electrode assembly, but that is not a requirement. In some embodiments, the width of the ion permeable membrane may be less than the width of at least one of the membrane electrode assembly and the discontinuous transport protection layer. In some embodiments, the width of the ion permeable membrane may be greater than the width of at least one of the membrane electrode assembly and the discontinuous transport protection layer.

The membrane-electrode assemblies of the present disclosure include at least one porous electrode. The porous electrode of the present disclosure is electrically conductive and the porosity facilitates the oxidation/reduction reaction that occur therein by increasing the amount of active surface area for reaction to occur, per unit volume of electrode, and by allowing the anolyte and catholyte to permeate into the porous regions and access this additional surface area. The porous electrodes (e.g. the first porous electrode and second porous electrodes) of the present disclosure may include at least one of carbon fiber based papers, felts and cloths. The porous electrodes may include at least one of woven and nonwoven fiber mats, woven and nonwoven fiber papers, felts and cloths (fabrics). In some embodiments, the porous electrode includes carbon fiber. The carbon fiber of the porous electrode may include, but is not limited to, glass like carbon, amorphous carbon, graphene, carbon nanotubes and graphite. Particularly useful porous electrode materials include carbon papers, carbon felts and carbon cloths (fabrics). In some embodiment, the porous electrode includes at least one of carbon paper, carbon felt and carbon cloth. In some embodiments, the porous electrode includes from about 30 percent to about 100 percent, from about 40 percent to about 100 percent, from about 50 percent to about 100 percent, from about 60 percent to about 100 percent, from about 70 percent to about 100 percent, from about 80 percent to about 100 percent, from about 90 percent to about 100 percent or even from about 95 percent to about 100 percent carbon fiber by weight. In some embodiments, the porous electrode includes from about 50 percent to about 100 percent, from about 60 percent to about 100 percent, from about 70 percent to about 100 percent, from about 80 percent to about 100 percent, from about 90 percent to about 100 percent, from about 95 percent to about 100 percent or even from about from about 97 percent to about 100 percent electrically conductive carbon particulate by weight. In some embodiments, the electrically conductive carbon particulate may include at least one of carbon particles, carbon flakes, carbon fibers, carbon dendrites, carbon nanotubes and branched carbon nanotubes; combinations may be used. In some embodiments, the electrically conductive carbon particulate may include at least one of graphite particles, graphite flakes, graphite fibers and graphite dendrites; combinations may be used. In some embodiments, the porous electrode includes from about 5 percent to about 100 percent, from about 10 percent to about 100 percent, from about 20 percent to about 100 percent, from about 35 percent to about 100 percent or even from about from about 50 percent to about 100 percent, by weight, of at least one of at least one of graphite particles, graphite flakes, graphite fibers and graphite dendrites.

Other porous electrodes useful in the electrode assemblies and membrane-electrode assemblies of the present disclosure include those included in pending U.S. Provisional Appl. Nos. 62/183,429, titled “Porous Electrodes and Electrochemical Cells and Liquid Flow Batteries Therefrom”, filed Jun. 23, 2015; 62/183,441, titled “Porous Electrodes and Electrochemical Cells and Liquid Flow Batteries Therefrom”, filed Jun. 23, 2015; 62/269,227, titled “Porous Electrodes, Membrane-Electrode Assemblies, Electrode Assemblies, and Electrochemical Cells and Liquid Flow Batteries Therefrom”, filed Dec. 18, 2015; and 62/269,239, titled “Porous Electrodes and Electrochemical Cells and Liquid Flow Batteries Therefrom”, filed Dec. 18, 2015, which are all incorporated herein by reference in their entirety.

The thickness of the porous electrode may be from about 10 microns to about 15000 microns, from about 10 microns to about 10000 microns, from about 10 microns to about 5000 microns, from about 10 microns to about 1000 microns, from about 10 microns to about 500 microns, from about 10 microns to about 250 microns, from about 10 microns to about 100 microns, from about 25 microns to about 15000 microns, from about 25 microns to about 10000 microns, from about 25 microns to about 5000 microns, from about 25 microns to about 1000 microns, from about 25 microns to about 500 microns, from about 25 microns to about 250 microns, or even from about 25 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent.

The porous electrode may be a single layer or multiple layers of woven and nonwoven fiber mats; and woven and nonwoven fiber papers, felts, and cloths; multi-layer papers and felts having particular utility. When multiple layers are used, the electrodes may be laminated together using an adhesive. When the porous electrode includes multiple layers, there is no particular limit as to the number of layers that may be used. However, as there is a general desire to minimize the number of layers of the electrode assemblies and the membrane-electrode assemblies of the present disclosure in order to reduce cost and/or the number of assembly steps, the porous electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of woven and nonwoven fiber mats and woven and nonwoven fiber papers, felts, cloths, and foams. In some embodiments the porous electrode includes from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of carbon paper, carbon felt and/or carbon cloth.

In some embodiments, the porous electrode may be surface treated to enhance the wettability of the porous electrode to a given anolyte or catholyte or to provide or enhance the electrochemical activity of the porous electrode relative to the oxidation-reduction reactions associated with the chemical composition of a given anolyte or catholyte. Surface treatments include, but are not limited to, at least one of chemical treatments, thermal treatments and plasma treatments. Thermal treatments of porous electrodes may include heating to elevated temperatures in an oxidizing atmosphere, e.g. oxygen and air. Thermal treatments may be at temperatures from about 100 to about 1000 degrees centigrade, from about 100 to about 850 degrees centigrade, from about 100 to about 700 degrees centigrade, 200 to about 1000 degrees centigrade, from about 200 to about 850 degrees centigrade, from about 200 to about 700 degrees centigrade, from about 300 to about 1000 degrees centigrade, from about 300 to about 850 degrees centigrade, or even from about 300 to about 700 degrees centigrade. The duration of the thermal treatment may be from about 0.1 hours to about 60 hours, from about 0.25 hour to about 60 hours, from about 0.5 hour to about 60 hours, from about 1 hour to about 60 hours, from about 3 hours to about 60 hours, from about 0.1 hours to about 48 hours, from about 0.25 hour to about 48 hours, from about 0.5 hour to about 48 hours, from about 1 hour to about 48 hours, from about 3 hours to about 48 hours, from about 0.1 hours to about 24 hours, from about 0.25 hour to about 24 hours, from about 0.5 hour to about 24 hours, from about 1 hour to about 24 hours from about 3 hours to about 24 hours, from about 0.1 hours to about 12 hours, from about 0.25 hour to about 12 hours, from about 0.5 hour to about 12 hours, from about 1 hour to about 12 hours, or even from about 3 hours to about 48 hours. In some embodiments, the porous electrode includes at least one of a carbon paper, carbon felt and carbon cloth that has been thermally treated in at least one of an air, oxygen, hydrogen, nitrogen, argon and ammonia atmosphere at a temperature from about 300 degrees centigrade to about 700 degrees centigrade for between about 0.1 hours and 48 hours.

In some embodiments, the porous electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments, the porous electrode may have a surface contact angle with water, catholyte and/or anolyte of less than 90 degrees. In some embodiments, the porous electrode may have a surface contact angle with water, catholyte and/or anolyte of between about 90 degrees and about 0 degrees, of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

The discontinuous transport protection layers, porous electrodes, membranes, and the corresponding membrane-electrode assemblies of the present disclosure may be used to fabricate an electrochemical cell for use in, for example, a liquid flow battery, e.g. a redox flow battery. In some embodiments, the present disclosure provides an electrochemical cell that include at least one membrane-electrode assembly. In another embodiment, the present disclosure provides an electrochemical cell including a membrane-electrode assembly according to any one of the membrane-electrode assemblies of the present disclosure.

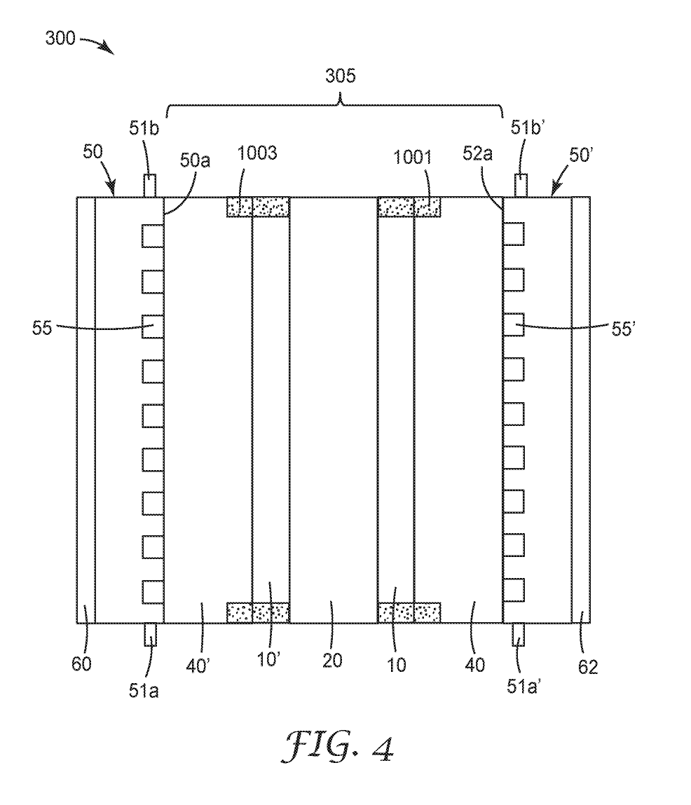

FIG. 4 shows a schematic cross-sectional side view of an exemplary electrochemical cell according to one exemplary embodiment of the present disclosure. Electrochemical cell 300 includes membrane-electrode assembly 305 comprising porous electrodes 40 and 40′, discontinuous transport protection layers 10 and 10′, adhesive layers 1001 and 1003 and ion permeable membrane 20, all as previously described. Electrochemical cell 300 includes end plates 50 and 50′ having fluid inlet ports, 51a and 51a′, respectively, and fluid outlet ports, 51b and 51b′, respectively, flow channels 55 and 55′, respectively, and first surface 50a and 52a respectively. Electrochemical cell 300 also includes current collectors 60 and 62. End plates 50 and 51 are in electrical communication with porous electrodes 40, through surfaces 50a and 52a, respectively. Support plates, not shown, may be placed adjacent to the exterior surfaces of current collectors 60 and 62. The support plates are electrically isolated from the current collector and provide mechanical strength and support to facilitate compression of the cell assembly. Membrane-electrode assembly 305, may include any of the membrane-electrode assemblies of the present disclosure, for example, membrane-electrode assemblies 100a through 100n (FIGS. 1A through 1P) and membrane-electrode assemblies 200a through 200d (FIGS. 2A through 2E). Membrane-electrode assembly 305 may be any of the membrane-electrode assemblies, having a single porous electrode, described herein. Membrane-electrode assembly 305 may be any of the membrane-electrode assemblies, having two porous electrodes, described herein.

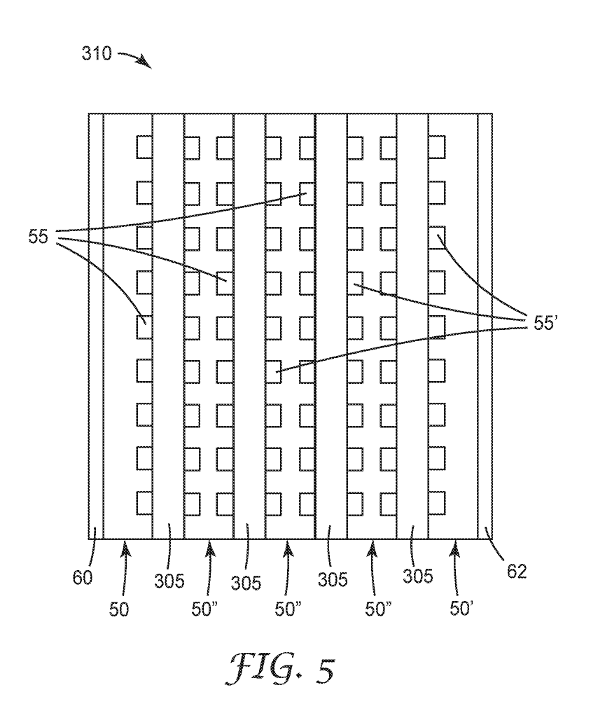

Individual electrochemical cells may be arranged to form an electrochemical cell stack. The electrochemical cell stacks of the present disclosure may include a plurality of membrane-electrode assemblies, as previously described herein. In one embodiment, the present disclosure provides an electrochemical cell stack including at least two, at least three, at least four membrane-electrode assemblies, according to any one of the membrane-electrode assemblies of the present disclosure. FIG. 5 shows a schematic cross-sectional side view of an exemplary electrochemical cell stack according to one exemplary embodiment of the present disclosure. Electrochemical cell stack 310 includes membrane-electrode assemblies 305, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 310 includes multiple electrochemical cells, each cell represented by a membrane-electrode assembly and the corresponding adjacent bipolar plates and/or end plates. Membrane-electrode assemblies 305 may include any of the membrane-electrode assemblies of the present disclosure. Within an electrochemical cell stack, the membrane-electrode assemblies may be the same or may be different. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system is not shown. These features may be provided as known in the art.

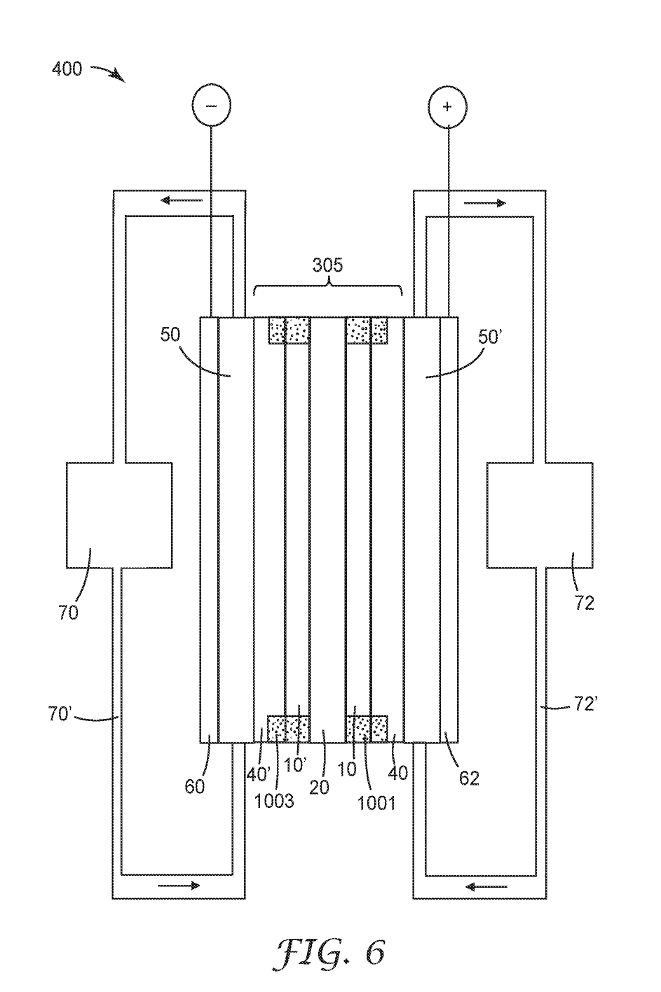

The discontinuous transport protection layers, porous electrodes and ion permeable membranes, and their corresponding membrane-electrode assemblies of the present disclosure may be used to fabricate liquid flow batteries, e.g. a redox flow battery. In some embodiments, the present disclosure provides a liquid flow battery that includes at least one membrane-electrode assembly of the present disclosure. In one embodiment, the present disclosure provides a liquid flow battery including a membrane-electrode assembly according to any one of the membrane-electrode assemblies of the present disclosure, for example, membrane-electrode assemblies 100a through 100n and membrane-electrode assemblies 200a through 200d. FIG. 6 shows a schematic view of an exemplary single cell, liquid flow battery according to one exemplary embodiment of the present disclosure. Liquid flow battery 400 includes porous electrodes 40 and 40′, discontinuous transport protection layers 10 and 10′, adhesive layers 1001 and 1003 and ion permeable membrane 20, all as previously described. The porous electrodes 40 and 40′, discontinuous transport protection layers 10 and 10′ and membrane 20 may be included in liquid flow battery 400 as membrane-electrode assembly 305 as previously described, and may include any of the membrane-electrode assemblies of the present disclosure. The Liquid flow battery 400 also includes end plates 50 and 50′ having flow channels (flow channels not shown), current collectors 60 and 62, anolyte reservoir 70 and anolyte fluid distribution 70′, and catholyte reservoir 72 and catholyte fluid distribution system 72′. Pumps for the fluid distribution system are not shown. Current collectors 60 and 62 may be connected to an external circuit which includes an electrical load (not shown). Support plates, not shown, may be placed adjacent to the exterior surfaces of current collectors 60 and 62. The support plates are electrically isolated from the current collector and provide mechanical strength and support to facilitate compression of the cell assembly. Although a single cell liquid flow battery is shown, it is known in the art that liquid flow batteries may contain multiple electrochemical cells, i.e. a cell stack. Multiple cell stacks may be used to form a liquid flow battery, e.g. multiple cell stacks connected in series. The discontinuous transport protection layers, porous electrodes and ion exchange membranes, and their corresponding membrane-electrode assemblies of the present disclosure may be used to fabricate liquid flow batteries having multiple cells, for example, the multiple cell stack of FIG. 5. Flow fields may be present, but this is not a requirement.

The membrane-electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, as described in the Example section of the present disclosure, which includes at least one of a an electrode assembly and membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane, i.e. laterally across the cell, shown in FIG. 4 or FIG. 6. In some embodiments, a test cell, as described in the Example section of the present disclosure, which includes at least one of an electrode assembly and membrane-electrode assembly of the present disclosure may have a cell resistance of between about 0.01 and about 10 ohm-cm², 0.01 and about 5 ohm-cm², between about 0.01 and about 3 ohm-cm², between about 0.01 and about 1 ohm-cm², between about 0.04 and about 5 ohm-cm², between about 0.04 and about 3 ohm-cm², between about 0.04 and about 0.5 ohm-cm², between about 0.07 and about 5 ohm-cm², between about 0.07 and about 3 ohm-cm² or even between about 0.07 and about 0.1 ohm-cm².

In some embodiments of the present disclosure, the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴/Ce³⁺ vs. V²⁺/V³⁺, Fe³⁺/Fe²⁺ vs. Br₂/Br⁻, Mn²⁺/Mn³⁺ vs. Br₂/Br⁻, Fe³⁺/Fe²⁺, vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Publ. Nos. 2014/0028260, 2014/0099569, and 2014/0193687 and organic complexes, for example, U.S. Pat. Publ. No. 2014/0370403 and international application published under the patent cooperation treaty Int. Publ. No. WO 2014/052682, all of which are incorporated herein by reference in their entirety.

Select embodiments of the present disclosure include, but are not limited to, the following:

In a first embodiment, the present disclosure provides a membrane-electrode assembly comprising:

a first porous electrode;

an ion permeable membrane, having a first major surface and an opposed second major surface;

a first discontinuous transport protection layer disposed between the first porous electrode and the first major surface of the ion permeable membrane; and

a first adhesive layer in contact with the first porous electrode and at least one of the first discontinuous transport protection layer and the ion permeable membrane, wherein the first adhesive layer is disposed along the perimeter of the membrane-electrode assembly, wherein the first porous electrode and first discontinuous transport protection layer, without the presence of the first adhesive layer, are not an integral structure and wherein the membrane-electrode assembly is an integral structure.

In a second embodiment, the present disclosure provides a membrane-electrode assembly according to the first embodiment, wherein the first adhesive layer is at least partially embedded in at least one of the first discontinuous transport protection layer and the first porous electrode.

In a third embodiment, the present disclosure provides a membrane-electrode assembly according to the first or second embodiments, wherein the first adhesive layer adheres the first discontinuous transport protection layer to the first porous electrode.

In a fourth embodiment, the present disclosure provides a membrane-electrode assembly according to any one of the first through third embodiments, wherein the first adhesive layer adheres at least one of the first discontinuous transport protection layer and the first porous electrode to the ion permeable membrane.

In a fifth embodiment, the present disclosure provides a membrane-electrode assembly according to any one of the first through third embodiments, further comprising a second adhesive layer in contact with the first major surface of the ion permeable membrane and the first discontinuous transport protection layer, wherein the second adhesive layer adheres the first discontinuous transport protection layer to the ion permeable membrane and wherein the second adhesive layer is disposed along the perimeter of the membrane-electrode assembly.

In a sixth embodiment, the present disclosure provides a membrane-electrode assembly according to the fifth embodiment, wherein the second adhesive layer is at least partially embedded in the first discontinuous transport protection layer.

In a seventh embodiment, the present disclosure provides a membrane-electrode assembly according to any one of the first through third embodiments, further comprising a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus.

In an eighth embodiment, the present disclosure provides a membrane-electrode assembly according to the seventh embodiment, further comprising at least one of a first gasket adhesive layer in contact with the first major surface of the first gasket and the first major surface of the ion permeable membrane; and a second adhesive layer in contact with the second major surface of the first gasket and the first discontinuous transport protection layer.

In a ninth embodiment, the present disclosure provides a membrane-electrode assembly according to any one of the first through eighth embodiments, wherein the first adhesive layer is at least one of a pressure sensitive adhesive, a hot melt adhesive and a thermosetting adhesive.

In a tenth embodiment, the present disclosure provides a membrane-electrode assembly according to any one of the first through ninth embodiments, wherein the first adhesive layer is in the shape of an annulus or is two discrete adhesive lines on opposite sides of the membrane-electrode assembly perimeter.

In an eleventh embodiment, the present disclosure provides a membrane-electrode assembly according to any one of the fifth, sixth and eighth embodiments, wherein the second adhesive layer is at least one of a pressure sensitive adhesive, a hot melt adhesive and a thermosetting adhesive.

In a twelfth embodiment, the present disclosure provides a membrane-electrode assembly according to any one of the fifth, sixth, eighth and eleventh embodiments, wherein the second adhesive layer is in the shape of an annulus or is two discrete adhesive lines on opposite sides of the membrane-electrode assembly perimeter.

In a thirteenth embodiment, the present disclosure provides a membrane-electrode assembly according to the eighth embodiment, wherein the first gasket adhesive layer includes at least one of a pressure sensitive adhesive, a hot melt adhesive and a thermosetting adhesive.

In a fourteenth embodiment, the present disclosure provides a membrane-electrode assembly according to the eighth or thirteenth embodiments, wherein the first gasket adhesive layer is in the shape of an annulus.

In a fifteenth embodiment, the present disclosure provides a membrane-electrode assembly according to any one of the seventh through fourteenth embodiments, wherein the first gasket includes at least one of polyester, polyamide, polycarbonate, polyimide, polysulphone, polyphenylene oxide, polyethylene naphthalate, polyacrylates, polymethacylates, polyolefin, styrene and styrene based random and block copolymers, polyvinyl chloride, and fluorinated polymer.

In a sixteenth embodiment, the present disclosure provides a membrane-electrode assembly according to any one of the first through fifteenth embodiments, further comprising a second porous electrode; and a second discontinuous transport protection layer disposed between the second porous electrode and the second major surface of the ion permeable membrane.

In a seventeenth embodiment, the present disclosure provides a membrane-electrode assembly according to the sixteenth embodiment, further comprising a third adhesive layer in contact with the second porous electrode and at least one of the second discontinuous transport protection layer and the ion permeable membrane, wherein the third adhesive layer is disposed along the perimeter of the membrane-electrode assembly, wherein the second porous electrode and second discontinuous transport protection layer, without the presence of the third adhesive layer, are not an integral structure and wherein the membrane-electrode assembly is an integral structure.

In an eighteenth embodiment, the present disclosure provides a membrane-electrode assembly according to the seventeenth embodiment, wherein the third adhesive layer is at least partially embedded in at least one of the second discontinuous transport protection layer and the second porous electrode.

In a nineteenth embodiment, the present disclosure provides a membrane-electrode assembly according to the seventeenth or eighteenth embodiments, wherein the third adhesive layer adheres the second discontinuous transport protection layer to the second porous electrode.

In a twentieth embodiment, the present disclosure provides a membrane-electrode assembly according to any one of the seventeenth through nineteenth embodiments, wherein the third adhesive layer adheres at least one of the second discontinuous transport protection layer and the second porous electrode to the ion permeable membrane.

In a twenty-first embodiment, the present disclosure provides a membrane-electrode assembly according to any one of the seventeenth through nineteenth embodiments, further comprising a fourth adhesive layer in contact with the second major surface the ion permeable membrane and the second discontinuous transport protection layer, wherein the fourth adhesive layer adheres the second discontinuous transport protection layer to the ion permeable membrane and wherein the fourth adhesive layer is disposed along the perimeter of the membrane-electrode assembly.

In a twenty-second embodiment, the present disclosure provides a membrane-electrode assembly according to the twenty-first embodiment, wherein the fourth adhesive layer is at least partially embedded in the second discontinuous transport protection layer.

In a twenty-third embodiment, the present disclosure provides a membrane-electrode assembly according to anyone of the sixteenth through eighteenth embodiments, further comprising a second gasket having a first major surface and a second major surface disposed between the ion permeable membrane and the second discontinuous transport protection layer, wherein the second gasket is disposed along the perimeter of the membrane-electrode assembly and the second gasket is in the shape of an annulus.

In a twenty-fourth embodiment, the present disclosure provides a membrane-electrode assembly according to the twenty-third embodiment, further comprising at least one of a second gasket adhesive layer in contact with the first major surface of the second gasket and the second major surface of the ion permeable membrane and a fourth adhesive layer in contact with the second major surface of the second gasket and the second discontinuous transport protection layer.

In a twenty-fifth embodiment, the present disclosure provides a membrane-electrode assembly according to anyone of the seventeenth through twenty-fourth embodiments, wherein the third adhesive layer is at least one of a pressure sensitive adhesive, a hot melt adhesive and a thermosetting adhesive.

In a twenty-sixth embodiment, the present disclosure provides a membrane-electrode assembly according to anyone of the seventeenth through twenty-fifth embodiments, wherein the third adhesive layer is in the shape of an annulus or is two discrete adhesive lines on opposite sides of the membrane-electrode assembly perimeter.

In a twenty-seventh embodiment, the present disclosure provides a membrane-electrode assembly according to anyone of the twenty-first, twenty-second and twenty-fourth embodiments, wherein the fourth adhesive layer is at least one of a pressure sensitive adhesive, a hot melt adhesive and a thermosetting adhesive.

In a twenty-eighth embodiment, the present disclosure provides a membrane-electrode assembly according to anyone of the twenty-first, twenty-second, twenty-fourth and twenty-fifth embodiments, wherein the fourth adhesive layer is in the shape of an annulus or is two discrete adhesive lines on opposite sides of the membrane-electrode assembly perimeter.

In a twenty-ninth embodiment, the present disclosure provides a membrane-electrode assembly according to the twenty-fourth embodiment, wherein the second gasket adhesive layer is at least one of a pressure sensitive adhesive, a hot melt adhesive and a thermosetting adhesive.

In a thirtieth embodiment, the present disclosure provides a membrane-electrode assembly according to the twenty-fourth or twenty-ninth embodiments, wherein the second gasket adhesive layer is in the shape of an annulus.

In a thirty-first embodiment, the present disclosure provides a membrane-electrode assembly according to any one of the twenty-third through thirtieth embodiments, wherein the second gasket includes at least one of wherein the first gasket includes at least one of polyester, polyamide, polycarbonate, polyimide, polysulphone, polyphenylene oxide, polyethylene naphthalate, polyacrylates, polymethacylates, polyolefin, styrene and styrene based random and block copolymers, polyvinyl chloride, and fluorinated polymer.

In a thirty-second embodiment, the present disclosure provides a membrane-electrode assembly according to any one of the first through thirty-first embodiments, wherein the first discontinuous transport protection layer comprises at least one of a mesh structure, a woven structure or a non-woven structure.

In a thirty-third embodiment, the present disclosure provides a membrane-electrode assembly according to any one of the sixteenth through thirty-second embodiments, wherein the second discontinuous transport protection layer comprises at least one of a mesh structure, a woven structure or a non-woven structure.

In a thirty-fourth embodiment, the present disclosure provides a membrane-electrode assembly according to any one of the first through thirty-third embodiments, wherein the first porous electrode is at least one of carbon fiber based papers, felts, and cloths.

In a thirty-fifth embodiment, the present disclosure provides a membrane-electrode assembly according to any one of the sixteenth through thirty-fourth embodiments, wherein the second porous electrode is at least one of carbon fiber based papers, felts, and cloths.

In a thirty-sixth embodiment, the present disclosure provides a membrane-electrode assembly according to any one of the first through thirty-third embodiments, wherein the first porous electrode includes from about 30 percent to about 100 percent electrically conductive carbon particulate by weight.

In a thirty-seventh embodiment, the present disclosure provides a membrane-electrode assembly according to any one of the sixteenth through thirty-fourth embodiments, wherein the second porous electrode includes from about 30 percent to about 100 percent electrically conductive carbon particulate by weight.

In a thirty-eighth embodiment, the present disclosure provides a membrane-electrode assembly according to any one of the first through thirty-seventh embodiments, wherein the first adhesive layer further comprises a plurality of first adhesive regions disposed at least within the interior of the membrane-electrode assembly and the area of the first plurality of adhesive regions, in the plane of the membrane electrode assembly, is less than at least 50 percent of the projected area of the membrane electrode assembly.

In a thirty-ninth embodiment, the present disclosure provides a membrane-electrode assembly according to any one of the seventeenth through thirty-seventh embodiments, wherein the third adhesive layer further comprises a plurality of third adhesive regions disposed at least within the interior of the membrane-electrode assembly and the area of the third plurality of adhesive regions, in the plane of the membrane electrode assembly, is less than at least 50 percent of the projected area of the membrane electrode assembly.

In a fortieth embodiment, the present disclosure provides a membrane-electrode assembly comprising:
a first porous electrode;
an ion permeable membrane, having a first major surface and an opposed second major surface,
a first discontinuous transport protection disposed between the first porous electrode and the ion permeable membrane; and

a first adhesive layer in contact with the first porous electrode and at least one of the first discontinuous transport protection layer and the ion permeable membrane, wherein the first adhesive layer is a plurality of first adhesive regions disposed at least within the interior of the membrane-electrode assembly and the area of the first plurality of adhesive regions, in the plane of the membrane electrode assembly, is less than at least 50 percent of the projected area of the membrane electrode assembly, wherein the first porous electrode and first discontinuous transport protection layer, without the presence of the first adhesive layer, are not an integral structure and wherein the membrane-electrode assembly is an integral structure.

In a forty-first embodiment, the present disclosure provides a membrane-electrode assembly according to the fortieth embodiment, wherein the first adhesive layer adheres the first porous electrode to the ion permeable membrane.

In a forty-second embodiment, the present disclosure provides a membrane-electrode assembly according to the fortieth or forty-first embodiments, further comprising a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus.

In a forty-third embodiment, the present disclosure provides an electrochemical cell comprising a membrane-electrode assembly according to any one of the first through forty-second embodiments.

In a forty-forth embodiment, the present disclosure provides a liquid flow battery comprising at least one membrane-electrode assembly according to any one of the first through forty-second embodiments.

### EXAMPLES

| Materials | |
|---|---|
| Abbreviation or Trade | |
| Name | Description |
| 3M 825EW | A perfluorosulphonic acid membrane |
| unsupported PFSA | prepared from 3M 825EW following the |
| membrane | membrane preparation procedure described in |
| | the EXAMPLE section of U.S. Pat. No. |
| | 7,348,088. |
| 3M 825EW supported | A perfluorosulphonic acid (PFSA) membrane |
| PFSA Membrane | prepared from an 825 equivalent weight 3M |
| | PFSA ionomer with an electrospun support |
| | layer (4.3 g/m² basis weight). The membrane |
| | was solution cast by methods outlined in |
| | patent application US 20140134518A1, with a |
| | final thickness of 20 micrometers. Such mem- |
| | branes are available through purchase from 3M |
| | Company, St. Paul, MN, USA, using this |
| | description. |
| GDL 35AA | Carbon paper, having a thickness of 280 +/− 30 |
| | micrometers under 5 pounds per square inch |
| | (PSI) (34.5 kPa) pressure, available under the |
| | trade designation “SIGRACET GDL 35AA” |
| | from SGL Group, Wiesbaden, Germany. |
| Infiana 100 micron | Low density polyethylene (LDPE) |
| LDPE | Film.74000.100 micron, available from |
| | Infiana Germany GmbH & Co. KG, |
| | Zweibrueckenstrasse 15-25 91301 Forchheim, |
| | Germany. |
| TEONEX Q83 PEN | TEONEX Q83 2 mil (0.051 mm) Polyethylene |
| Film | Naphthalate Film available from Dupont |
| | Teijin Films, Chester, VA. |
| Sub 11 Glass Mat | Craneglas 230 (Crane & Co, Inc., Pittsfield, |
| | MA), available, under the trade designation |
| | “Sub 11”, from Electrolock Inc., Hiram, OH. |
| 9275T27 | 98 by 98 mesh, 4.3 mil (0.109 mm) wire |
| Polypropylene | diameter, 0.0059 inch (0.150 mm) open size, |
| Woven | 34% open area, available under part number |
| | 9275T27 from McMaster Carr, Elmhurst, IL. |

### Test Procedures/Methods:

### Electrochemical Cell Test Procedure for Comparative Example A

The hardware used was a modified fuel cell test fixture that utilizes two graphite bi-polar plates made by Fuel Cell Technologies (Albuquerque, N. Mex.), two gold plated copper current collectors and aluminum end plates. The graphite bi-polar plates have a 5 cm² single serpentine channel with an entry port on top and exit port on the bottom.

The test cell was assembled as follows. First, a 1.9 mil (0.048 mm) and 5.2 mil (0.132 mm) (7.1 mil (0.180 mm) total thickness) piece of polytetrafluoroethylene (PTFE) glass fiber composite gasket material (available from Nott Company, Arden Hills, Minn.) that had a 5 cm² area removed from the center were stacked and placed along the perimeter of the major surface of one graphite plate, the gasket being on the side of the plate having the serpentine channel. A piece of GDL 35AA, cut to the size of the gasket opening, was placed in the gasket opening and adjacent to the serpentine channel of the graphite plate. Next a 20 micrometer 3M 825EW supported PFSA membrane was placed over the gasket/electrode assembly. Next, another piece of 1.9 mil (0.048 mm) and 5.2 mil (0.132 mm) of gasket material, with a cavity, was placed onto the membrane. A second piece of GDL 35AA, cut to the size of the gasket cavity, was placed in the gasket cavity on the membrane. A second graphite plate was placed onto the stack, with the serpentine channels of the graphite plate adjacent the second piece of GDL 35AA, completing the test cell. The test cell was then placed between two aluminum end plates with current collectors and secured with a series of 8 bolts that are tightened to 110 in·lbs (12.4 N·m).

Connected to the entry and exit ports of the test cell was tubing that allows for delivery of the electrolyte, at a flow rate of 23 ml/min, to the serpentine channels of the cell by a KNF Neuberger NFB5 diaphragm pump (available from KNF Neuberger Inc., Trenton, N.J.). Electrolyte delivery was accomplished by pumping the fluid from one tank into the upper entry port, out the lower exit port and finally back into the original tank. A pumping system was setup for each graphite plate. The electrolyte used for these examples was 1.5 M VOSO₄, 2.6 M H₂SO₄. The VOSO₄*xH₂O powder is purchased from Sigma Aldrich (St. Louis, Mo., USA) and concentrated H₂SO₄ (95-98%) was purchased from Sigma Aldrich. The amount of water in the VOSO₄*xH₂O varies from lot to lot, but is known and solution concentrations were adjusted to account for this water. The final solution was made by the combination of these constituents with 18 M≤DI water at the stated molar ratios and mixed with a stir bar for two to three hours before use. A 30 ml catholyte solution containing 1.5 M VOSO₄ in 2.6 M sulfuric acid, charged to the V⁺⁵ state, was pumped through one side of the cell. In the other side of the cell 30 ml of anolyte solution containing 1.5 M VOSO₄ in 2.6 M sulfuric acid, charged to the V⁺² state, was pumped. In this setup the catholyte is reduced from V⁺⁵ to V⁺⁴ and the anolyte is oxidized from V⁺² to V⁺³ during discharge of the cell.

Electrochemical operation of the cell: The cell was next connected to a Biologic MPG-205 potentio/galvanostat with one current collector serving as the anode and the other current collector serving as the cathode. To perform a test the following steps were followed:

1. Ensure that electrolyte was flowing through the cell.

2. Charge the cell at 80 mA/cm² until a cell voltage of 1.8 V was reached.

3. Hold the cell voltage at 1.8 V until the current decays to 5 mA/cm².

4. Monitor the open circuit voltage for 120 seconds.

5. Discharge the cell at 160 mA/cm² for 120 seconds and record the voltage.

6. Monitor the open circuit voltage for 120 seconds.

7. Discharge the cell at 140 mA/cm² for 120 seconds and record the voltage.

8. Monitor the open circuit voltage for 120 seconds.

9. Discharge the cell at 120 mA/cm² for 120 seconds and record the voltage.

10. Monitor the open circuit voltage for 120 seconds.

11. Discharge the cell at 100 mA/cm² for 120 seconds and record the voltage.

12. Monitor the open circuit voltage for 120 seconds.

13. Discharge the cell at 80 mA/cm² for 120 seconds and record the voltage.

Cell resistance was calculated by subtracting the cell voltage while under load from the cell voltage at open circuit and dividing by the operating current.

### Electrochemical Cell Test Procedure for Examples 1 and 2:

The same Electrochemical Test Procedure described in the Electrochemical Test Procedure for Comparative Example A was used except: The test cell was assembled as follows. The membrane electrode assemblies created in Examples 1 and 2 were placed on the graphite bipolar plates. The test cell was then placed between two aluminum end plates with current collectors and secured with a series of 8 bolts that are tightened to 110 lbf·in (12.4 N·m).

### Subgasketed Membrane Preparation

3M 8171 Optically clear adhesive (available from 3M, St. Paul, Minn.) with one liner removed was laminated using a hand roller to TEONEX Q83 PEN Film (available from Dupont Teijin Films, Chester, Va.). Two pieces were die cut out of this lamination using a hand die from Mathias Die Company (St. Paul, Minn.). The die cut a 3 inch (7.6 cm)×3 inch (7.6 cm) square outer dimension and removed a 2.7 cm×2.7 cm inner square. One piece of 8171 adhesive/TEONEX Q83 PEN film with the second liner removed was laminated to a 20 micrometer 3M 825EW Supported PFSA Membrane with a hand roller. The 3M 825EW Supported PFSA Membrane/8171/TONEX Q83 PEN Film laminate was trimmed to have an outer square dimension of 3 inches (7.6 cm) per side. The second 8171 adhesive/TEONEX Q83 PEN film (previously die cut to a 3 inch (7.6 cm)×3 inch (7.6 cm) square outer dimension and a 2.7 cm×2.7 cm inner square opening), with a liner removed, was laminated onto the 3M 825EW Supported PFSA Membrane/8171/TONEX Q83 PEN Film laminate in registration using a hand roller to give a Subgasketed Membrane consisting of TEONEX Q83 PEN Film/8171/3M 825EW Supported PFSA Membrane/8171/TEONEX Q83 PEN Film.

### Example 1: 24 Gsm (Gram Per Square Meter) Polypropylene Nonwoven Membrane Electrode Assembly with One Carbon Paper Per Side and One Hot Melt Adhesive in Between Each Layer

A nonwoven web was formed using a Drilled Orifice Die. Meltblown fibers were created by a molten polymer entering the die, the flow being distributed across the width of the die in the die cavity and the polymer exiting the die through a series of orifices as filaments. A heated air stream passed through air manifolds and through an air knife assembly adjacent to the series of polymer orifices that form the die exit (tip). This heated air stream was adjusted for both temperature and velocity to attenuate (draw) the polymer filaments down to the desired fiber diameter. The meltblown fibers were conveyed in this turbulent air stream towards a rotating surface where they collect to form a web.

A roll of approximately 10 inch (25.4 cm) wide nonwoven web was collected under the conditions as follows: The MF-650X polypropylene polymer (manufactured by LyondellBasell, Rotterdam, Netherlands, and commercially available through Nexeo Solutions, The Woodlands, Tex.) was extruded through a 10 inch (25.4 cm) wide drilled orifice die (DOD) at 10 lb/hr (4.5 kg/hr). The polymer melt temperature was 366 degrees F. (185 degrees C.). The die-to-collector distance was 14 inches (35.6 cm). Samples of the web were collected on a Unipro 125, 42 g/m² spunbond scrim (available from Midwest Filtration LLC, Cincinnati, Ohio) at 40.5 ft/min (12.3 m/min), the meltblown web was separated from the scrim and evaluated for effective fiber diameter (EFD) according to the method set forth in Davies, C. N., “The Separation of Airborne Dust and Particles,” Institution of Mechanical Engineers, London Proceedings 1B, 1952. The air temperature and velocity were adjusted to achieve an effective fiber diameter of 21 micrometers. The basis weight of the web was 24 grams per square meter (gsm).

Hand dies from Mathias Die Company (St. Paul, Minn.) were used to cut the following materials in the layup below. The dies contained 2 small holes for alignment pins, one on an opposite side from the other outside the active area. The alignment holes were used to align the PTFE glass fiber composite gasket, Infiana 100 micron LDPE, and Subgasketed Membrane. Electrode and Transport Protection materials were aligned in the center cut out windows of the gasket and Infiana 100 micron LDPE. The following layup was prepared:
6 inch (15.2 cm)×6 inch (15.2 cm)×⅛ inch (0.32 cm) steel sheet with alignment pins.
4 (10.2 cm)×4 inch (10.2 cm) polyimide sheet 2 mil (0.051 mm) DuPont Kapton HN (available from DuPont High Performance Films, Circleville, Ohio) with alignment holes.
1 piece of 8.2 mil (0.21 mm) PTFE glass fiber composite gasket material (available from Nott Company, Arden Hills, Minn.) (outer dimension 3 inch square, inner dimension 2.7 cm×2.7 cm).
1 piece of GDL 35AA 2.7 cm×2.7 cm
1 piece of Infiana 100 micron LDPE (outer dimension 3 inch (7.6 cm) square, inner opening of 2.25 cm×2.25 cm).
1 piece of Polypropylene Nonwoven 24 gsm 2.7 cm×2.7 cm.
1 piece of Infiana 100 micron LDPE (outer dimension 3 inch (7.6 cm) square, inner opening of 2.25 cm×2.25 cm)
1 Subgasketed Membrane.
1 piece of Infiana 100 micron LDPE (outer dimension 3 inch (7.6 cm) square, inner opening of 2.25×2.25 cm).
1 piece of Polypropylene Nonwoven 24 gsm, 2.7 cm×2.7 cm.
1 piece of Infiana 100 micron LDPE (outer dimension 3 inch square, inner opening of 2.25 cm×2.25 cm)
1 piece of GDL 35AA 2.7 cm×2.7 cm.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
4 inch (10.2 cm)×4 inch (10.2 cm)×2.0 mil (0.051 mm)polyimide sheet with alignment holes
6 inch (15.2 cm)×6 inch (15.2 cm)×⅛ inch (0.32 cm) steel sheet with alignment pins

This layup was placed in a Carver Press Model 2518 (available from Fred S. Carver Inc., Wabash, Ind.) at 240 degrees Fahrenheit. The layup was placed under 2500 lb (1130 kg), which decayed to 600 lb (272 kg) during the 7 minute dwell time. After 7 minutes the sample was removed and placed between two 12 inch (30.5 cm×18 inch 45.7 cm)×1 inch (2.54 cm) metal sheets at room temperature to cool for 2 minutes. After cooling, the steel plates, polyimide, and PTFE glass fiber composite gasket material were removed from each side of the layup, yielding the completed membrane electrode assembly forming an integral structure. The sample was placed in a cell and tested as described by the Cell Test Procedure for Example 1 and 2. Cell Resistance results are shown in Table 1.

### Example 2: Glass Mat Membrane Electrode Assembly with One Carbon Paper Per Side and One Hot Melt Adhesive Between Each Pair of Layers

The same layup described in Example 1 was used with the following modification: the 24 gsm Polypropylene Nonwoven sample described in Example 1 was replaced with the 2.7 cm×2.7 cm Sub 11 Glass Mat.

This layup was placed in a Carver Press Model 2518 (available from Fred S. Carver Inc., Wabash, Ind.) at 240 degrees Fahrenheit (116 degrees centigrade). The layup was placed under 1500 lb (680 kg), which decayed to 500 lb (227 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling, the steel plates, polyimide, and PTFE glass fiber composite gasket material were removed from each side of the layup, yielding the completed membrane electrode assembly forming an integral structure. The sample was placed in a cell and tested as described by the Cell Test Procedure for Example 1 and 2. Cell Resistance results are shown in Table 1.

### Example 3: 24 Gsm (Gram Per Square Meter) Polypropylene Nonwoven Membrane Electrode Assembly with Two Carbon Papers Per Side and One Hot Melt Adhesive in Between Each Pair of Layers

The same 24 gsm Polypropylene Nonwoven was used as described in Example 1. The same procedures described in Example 1 were used to form an integral structure with the following layup:
6 (15.2 cm)×6 inch (15.2 cm)×⅛ (0.32 cm) inch steel sheet with alignment pins.
4 inch (10.2 cm)×4 inch (10.2 cm)×2.0 mil (0.051 mm) polyimide sheet with alignment holes.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
1 piece of GDL 35AA 2.7 cm×2.7 cm.
1 piece of Infiana 100 micron LDPE (outer dimension 3 inch (7.6 cm) square, inner opening of 2.25×2.25 cm square).
1 piece of GDL 35AA 2.7 cm×2.7 cm.
1 piece of Infiana 100 micron LDPE (outer dimension 3 inch (7.6 cm) square, inner opening of 2.25 cm×2.25 cm).
1 piece of Polypropylene Nonwoven 24 gsm 2.7 cm×2.7 cm
1 piece of Infiana 100 micron LDPE (outer dimension 3 (7.6 cm) inch square, inner opening of 2.25 cm×2.25 cm).
1 Subgasketed Membrane.
1 piece of Infiana 100 micron LDPE (outer dimension 3 inch (7.6 cm) square, inner opening of 2.25 cm×2.25 cm).
1 piece of Polypropylene Nonwoven 24 gsm 2.7 cm×2.7 cm.
1 piece of Infiana 100 micron LDPE (outer dimension 3 inch (7.6 cm) square, inner opening of 2.25 cm×2.25 cm)
1 piece of GDL 35AA 2.7 cm×2.7 cm.
1 piece of Infiana 100 micron LDPE (outer dimension 3 inch (7.6 cm) square, inner opening of 2.25 cm×2.25 cm).
1 piece of GDL 35AA 2.7 cm×2.7 cm.
1 piece of 8.2 mil (0.21 mm) PTFE glass fiber composite gasket material (available from Nott Company, Arden Hills, Minn.) (outer dimension 3 (7.6 cm) inch square, inner dimension 2.7 cm×2.7 cm).
4 inch (10.2 cm)×4 inch (10.2 cm)×2.0 mil (0.051 mm) polyimide sheet with alignment holes.
6 inch (15.2 cm)×6 inch (15.2 cm)×⅛ inch (0.32 cm) steel sheet with alignment pins.

This layup was placed in a Carver Press Model 2518 (available from Fred S. Carver Inc., Wabash, Ind.) at 240 degrees Fahrenheit (116 degrees centigrade). The layup was placed under 1500 lb (680 kg), which decayed to 500 lb (227 kg) during the 6 minute dwell time. After 6 minutes the sample was removed and placed between two 12 inch (30.5 cm)×18 inch (45.7 cm)×1 inch (2.5 cm) metal sheets at room temperature to cool for 2 minutes. After cooling, the steel plates, polyimide, and PTFE glass fiber composite gasket material were removed from each side of the layup, yielding the completed membrane electrode assembly forming an integral structure.

### Example 4: 24 Gsm (Gram Per Square Meter) Polypropylene Nonwoven Membrane Electrode Assembly with One Carbon Paper Per Side and One Layer of Hot Melt Adhesive Per Side

The same 24 gsm Polypropylene Nonwoven was used as described in Example 1. The same procedures described in Example 1 were used to form an integral structure with the following layup:
6 inch (15.2 cm)×6 inch (15.2)×⅛ inch (0.32 cm) steel sheet with alignment pins.
4 inch (10.2 cm)×4 inch (10.2 cm)×2 mil (0.051 mm) polyimide sheet with alignment holes
1 piece of 8.2 mil (0.21 mm) PTFE glass fiber composite gasket material (available from Nott Company, Arden Hills, Minn.) (outer dimension 3 inch (7.6 mm) square, inner dimension 2.7 cm×2.7 cm).
1 piece of GDL 35AA 2.7 cm×2.7 cm.
1 piece of Polypropylene Nonwoven 24 gsm 2.7 cm×2.7 cm.
2 pieces of Infiana 100 micron LDPE (outer dimension 3 inch square, inner opening of 2.25 cm×2.25 cm).
1 Subgasketed Membrane.
2 pieces of Infiana 100 micron LDPE (outer dimension 3 inch (7.6 cm) square, inner opening of 2.25 cm×2.25 cm).
1 piece of Polypropylene Nonwoven 24 gsm 2.7 cm×2.7 cm.
1 piece of GDL 35AA 2.7 cm×2.7 cm.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
4 inch (10.2 cm)×4 (10.2 cm)×2.0 mil (0.051 mm) polyimide sheet with alignment holes.
6 inch (15.2 cm)×6 inch (15.2 cm)×⅛ inch (0.32 cm) steel sheet with alignment pins.

This layup was placed in a Carver Press Model 2518 (available from Fred S. Carver Inc., Wabash Ind.) at 240 degrees Fahrenheit (116 degrees centigrade). The layup was placed under 1500 lb (680 kg), which decayed to 500 lb (227 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling, the steel plates, polyimide, and PTFE glass fiber composite gasket material were removed from each side of the layup, yielding the completed membrane electrode assembly forming an integral structure.

### Example 5: 24 Gsm (Gram Per Square Meter) Polypropylene Nonwoven Membrane Electrode Assembly with One Carbon Paper Per Side and One Layer of Hot Melt Adhesive Between Each Pair of Layers Around Perimeter and within the Cell Active Area

The same 24 gsm Polypropylene Nonwoven was used as described in Example 1. The same procedures described in Example 1 were used to form an integral structure with the following layup:
6 inch (15.2 cm)×6 inch (15.2)×⅛ inch (0.32 cm) steel sheet with alignment pins.
4 inch (10.2 cm) by 4 inch (10.2 cm) polyimide sheet 2 mil (0.051 mm) polyimide sheet with alignment holes.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
1 piece of GDL 35AA 2.7 cm×2.7 cm.
1 piece of 0.5 cm×0.5 cm Infiana 100 micron LDPE placed in center of GDL 35AA.
1 piece of Infiana 100 micron LDPE (outer dimension 3 inch (7.6 cm) square, inner opening of 2.25 cm×2.25 cm square).
1 piece of Polypropylene Nonwoven 24 gsm 2.7 cm×2.7 cm.
1 piece of 0.5 cm×0.5 cm Infiana 100 micron LDPE placed in center of Polypropylene Nonwoven.
1 piece of Infiana 100 micron LDPE (outer dimension 3 inch (7.6 cm) square, inner opening of 2.25 cm×2.25 cm square).
1 Subgasketed Membrane.
1 piece of Infiana 100 micron LDPE (outer dimension 3 inch (7.6 cm) square, inner opening of 2.25 cm×2.25 cm square).
1 piece of 0.5 cm×0.5 cm Infiana 100 micron LDPE placed in center of the membrane laminate.
1 piece of Polypropylene Nonwoven 24 gsm 2.7 cm×2.7 cm
1 piece of 0.5 cm×0.5 cm Infiana 100 micron LDPE placed in center of the polypropylene nonwoven.
1 piece of Infiana 100 micron LDPE die cut for subgasket size (outer dimension 3 inch (7.6 cm) square, inner opening of 2.25 cm×2.25 cm square).
1 piece of GDL 35AA 2.7 cm×2.7 cm
1 piece of 8.2 mil PTFE glass fiber composite gasket material (available from Nott Company, Arden Hills, Minn.) (outer dimension 3 inch (7.6 cm) square, inner dimension 2.7 cm×2.7 cm).
4 inch (10.2 cm)×4 inch (10.2 cm)×2.0 mil (0.051 mm) polyimide sheet with alignment holes.
6 inch (15.2 cm)×6 inch (15.2 cm)×⅛ inch (0.32 cm) steel sheet with alignment pins.

This layup was placed in a Carver Press Model 2518 (available from Fred S. Carver Inc., Wabash, Ind.) at 240 degrees Fahrenheit (116 degrees centigrade). The layup was placed under 1500 lb (690 kg), which decayed to 500 lb (227 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling, the steel plates, polyimide, and PTFE glass fiber composite gasket material was were removed from each side of the layup, yielding the completed membrane electrode assembly forming an integral structure.

### Example 6: 24 Gsm (Gram Per Square Meter) Polypropylene Nonwoven Membrane Electrode Assembly Cut within Subgasketed Membrane Opening, One Carbon Paper Per Side and One Layer of Hot Melt Adhesive Between Gasket and Electrode Around Perimeter

The same layup described in Example 1 was used here with the following modification: the 24 gsm Polypropylene Nonwoven sample described in Example 1 was replaced with 24 gsm Polypropylene Nonwoven cut to 2.25 cm×2.25 cm to fit within the 2.25 cm×2.25 cm opening of the Infiana 100 micron LDPE (outer dimension 3 inch (7.6 cm) square, inner opening of 2.25 cm×2.25 cm).

This layup was placed in a Carver Press Model 2518 (available from Fred S. Carver Inc., Wabash Ind.) at 240 degrees Fahrenheit (116 degrees centigrade). The layup was placed under 1500 lb (680 kg), which decayed to 600 lb (272 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling the steel plates, polyimide, and PTFE glass fiber composite gasket material was removed from each side of the layup, yielding the completed membrane electrode assembly forming an integral structure.

### Annealed 9275T27 Polypropylene Woven Sample Preparation:

A sample cut from a roll of 9275T27 Polypropylene Woven was placed in a aluminum pan in a ventilated oven at 100 degrees C. After 15 minutes, the sample was removed and allowed to cool to room temperature.

### Example 7: 9275T27 Polypropylene Woven Membrane Electrode Assembly, One Carbon Paper Per Side and One Layer of Hot Melt Between Each Layer

The same layup described in Example 1 was used here with the following modification: the 24 gsm Polypropylene Nonwoven sample described in Example 1 was replaced by the 2.7 cm×2.7 cm Annealed 9275T27 Polypropylene Woven described in the Annealed 9275T27 Polypropylene Woven Sample Preparation above.

This layup was placed in a Carver Press Model 2518 (available from Fred S. Carver Inc, Wabash Ind.) at 240 degrees Fahrenheit (116 degrees centigrade). The layup was placed under 1500 lb (680 kg), which decayed to 500 lb (227 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling the steel plates, polyimide, and PTFE glass fiber composite gasket material was removed from each side of the layup, yielding the completed membrane electrode assembly forming an integral structure.

### Example 8: 24 Gsm (Gram Per Square Meter) Polypropylene Nonwoven Membrane Electrode Assembly, One Carbon Paper Per Side and One Layer of Hot Melt Adhesive Between Each Layer, No Subgasket on Membrane

The same 24 gsm Polypropylene Nonwoven was used as described in Example 1. The same procedures described in Example 1 were used to form an integral structure with the following layup:
6 (15.2 cm)×6 inch (15.2 cm)×⅛ inch (2.5 cm) steel sheet with alignment pins.
4 inch (10.2 cm)×4 inch (10.2 cm) 2.0 mil (0.051 mm) polyimide sheet with alignment holes.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
1 piece of GDL 35AA 2.7 cm×2.7 cm.
1 piece of Infiana 100 micron LDPE (outer dimension 3 inch (7.6 cm) square, inner opening of 2.25 cm×2.25 cm square).
1 piece of Polypropylene Nonwoven 24 gsm 2.7 cm×2.7 cm
1 piece of Infiana 100 micron LDPE (outer dimension 3 inch (7.6 cm) square, inner opening of 2.25 cm×2.25 cm square).
1 20 micron 3M 825EW Supported PFSA membrane.
1 piece of Infiana 100 micron LDPE (outer dimension 3 inch (7.6 cm) square, inner opening of 2.25 cm×2.25 cm square)
1 piece of Polypropylene Nonwoven 24 gsm 2.7 cm×2.7 cm
1 piece of Infiana 100 micron LDPE (outer dimension 3 (7.6 cm) inch square, inner opening of 2.25 cm×2.25 cm square)
1 piece of GDL 35AA 2.7 cm×2.7 cm.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
4 inch (10.2 cm)×4 inch (10.2 cm)×2.0 mil (0.051 mm) polyimide sheet with alignment holes.
6 inch (15.2 cm)×6 inch (15.2 cm)×⅛ inch (0.32 cm) steel sheet with alignment pins.
   This layup was placed in a Carver Press Model 2518 (available from Fred S. Carver Inc, Wabash Ind.) at 240 degrees Fahrenheit (116 degrees centigrade). The layup was placed under 1500 lb (680 kg), which decayed to 500 lb (227 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling the steel plates, polyimide, and PTFE glass fiber composite gasket material was removed from each side of the layup, yielding the completed membrane electrode assembly forming an integral structure.

### Comparative Example A (CE-A)

CE-A was single layer of GDL 35AA without a discontinuous transport protection layer.

### Cell Resistance Results

The electrode assemblies of CE-A and Examples 1-2 were used to fabricate liquid flow electrochemical cells, per the Electrochemical Cell procedures described above. Cell Resistance was measured as outlined in those same procedures and is presented in Table 1 below.

TABLE 1
Cell Resistance Results.

| | Total Cell Resistance |
|---|---|
| Sample | (Ohm-cm²) |
| CE-A | 1.695 |
| Example 1: 24 gsm | 1.608 |
| Polypropylene Nonwoven | |
| Example 2: Sub 11 Glass | 2.718 |
| Mat | |

1. A membrane-electrode assembly comprising:
a first porous electrode;
an ion permeable membrane, having a first major surface and an opposed second major surface;
a first discontinuous transport protection layer disposed between the first porous electrode and the first major surface of the ion permeable membrane, wherein the first discontinuous transport protection layer comprises at least one of a mesh structure, a woven structure, and a nonwoven structure; and
a first adhesive layer in contact with the first porous electrode and at least one of the first discontinuous transport protection layer and the ion permeable membrane, wherein the first adhesive layer is disposed along the perimeter of the membrane-electrode assembly, wherein the first porous electrode and first discontinuous transport protection layer, without the presence of the first adhesive layer, are not an integral structure and wherein the membrane-electrode assembly is an integral structure.

2. The membrane-electrode assembly of claim 1, wherein the first adhesive layer is at least partially embedded in at least one of the first discontinuous transport protection layer and the first porous electrode.

3-4. (canceled)

5. The membrane electrode assembly of claim 1, further comprising a second adhesive layer in contact with the first major surface of the ion permeable membrane and the first discontinuous transport protection layer, wherein the second adhesive layer adheres the first discontinuous transport protection layer to the ion permeable membrane and wherein the second adhesive layer is disposed along the perimeter of the membrane-electrode assembly.

6. (canceled)

7. The membrane-electrode assembly of claim 1, further comprising a first gasket having a first major surface and a second major surface disposed between the ion permeable membrane and at least one of the first discontinuous transport protection layer and the first porous electrode, wherein the first gasket is disposed along the perimeter of the membrane-electrode assembly and the first gasket is in the shape of an annulus.

8-9. (canceled)

10. The membrane-electrode assembly of claim 1, wherein the first adhesive layer is in the shape of an annulus or is two discrete adhesive lines on opposite sides of the membrane-electrode assembly perimeter.

11. (canceled)

12. The membrane-electrode assembly of claim 5, wherein the second adhesive layer is in the shape of an annulus or is two discrete adhesive lines on opposite sides of the membrane-electrode assembly perimeter.

13-14. (canceled)

15. The membrane-electrode assembly of claim 7, wherein the first gasket includes at least one of polyester, polyamide, polycarbonate, polyimide, polysulphone, polyphenylene oxide, polyethylene naphthalate, polyacrylates, polymethacylates, polyolefin, styrene and styrene based random and block copolymers, polyvinyl chloride, and fluorinated polymer.

16. The membrane-electrode assembly of claim 1 further comprising:
a second porous electrode; and
a second discontinuous transport protection layer disposed between the second porous electrode and the second major surface of the ion permeable membrane, wherein the first discontinuous transport protection layer comprises at least one of a mesh structure, a woven structure, and a nonwoven structure.

17. The membrane-electrode assembly of claim 16 further comprising a third adhesive layer in contact with the second porous electrode and at least one of the second discontinuous transport protection layer and the ion permeable membrane, wherein the third adhesive layer is disposed along the perimeter of the membrane-electrode assembly, wherein the second porous electrode and second discontinuous transport protection layer, without the presence of the third adhesive layer, are not an integral structure and wherein the membrane-electrode assembly is an integral structure.

18-20. (canceled)

21. The membrane electrode assembly of claim 17, further comprising a fourth adhesive layer in contact with the second major surface the ion permeable membrane and the second discontinuous transport protection layer, wherein the fourth adhesive layer adheres the second discontinuous transport protection layer to the ion permeable membrane and wherein the fourth adhesive layer is disposed along the perimeter of the membrane-electrode assembly.

22. (canceled)

23. The membrane-electrode assembly of claim 16, further comprising a second gasket having a first major surface and a second major surface disposed between the ion permeable membrane and the second discontinuous transport protection layer, wherein the second gasket is disposed along the perimeter of the membrane-electrode assembly and the second gasket is in the shape of an annulus.

24-33. (canceled)

34. The membrane-electrode assembly of claim 1, wherein the first porous electrode is at least one of carbon fiber based papers, felts, and cloths.

35. The membrane-electrode assembly of claim 16, wherein the second porous electrode is at least one of carbon fiber based papers, felts, and cloths.

36. The membrane-electrode assembly of claim 1, wherein the first porous electrode includes from about 30 percent to about 100 percent electrically conductive carbon particulate by weight.

37. The membrane-electrode assembly of claim 1, wherein the second porous electrode includes from about 30 percent to about 100 percent electrically conductive carbon particulate by weight.

38. The membrane-electrode assembly of claim 1, wherein the first adhesive layer further comprises a plurality of first adhesive regions disposed at least within the interior of the membrane-electrode assembly and the area of the first plurality of adhesive regions, in the plane of the membrane electrode assembly, is less than at least 50 percent of the projected area of the membrane electrode assembly

39-42. (canceled)

43. An electrochemical cell comprising a membrane-electrode assembly according to claim 1.

44. A liquid flow battery comprising at least one membrane-electrode assembly according to claim 1.
